(19) United States
(12) Patent Application Publication
(10) Pub. No.: US 2026/0301233 A1
(43) Pub. Date: Oct. 1, 2026

(54) COMPRESSING ANIMATION STREAM DATA FOR AUGMENTED REALITY (AR) COMMUNICATION SESSIONS

(71) Applicant: QUALCOMM Incorporated, San Diego, CA (US)

(72) Inventors: Imed Bouazizi, Celina, TX (US); Nikolai Konrad Leung, San Francisco, CA (US); Thomas Stockhammer, Bergen (DE)

(21) Appl. No.: 19/575,682

(22) Filed: Mar. 23, 2026

Related U.S. Application Data
(60) Provisional application No. 63/777,327, filed on Mar. 25, 2025.

(51) Int. Cl. G06T 9/00; G06T 13/40; G06T 19/00

(52) U.S. Cl. CPC G06T 9/001; G06T 13/40; G06T 19/006

(57) ABSTRACT

Animation data for an augmented reality (AR) communication session may be applied to a base avatar model to animate the base avatar model to represent movements of a user associated with the base avatar model. The animation data may be represented by movements (translation, rotation, and/or scaling) of joints and bones of a skeleton corresponding to the user. Rotations may be expressed using quaternions. To compress the animation data, a device may perform extraction and compression of quaternions separately; a device may perform hierarchical prediction of joint transforms based on a skeleton hierarchy; a device may perform temporal prediction through coding of difference data (deltas); and/or a device may perform quantization of transform components.

This application claims the benefit of U.S. Provisional Application No. 63/777,327, filed Mar. 25, 2025, the entire contents of which are hereby incorporated by reference.

### TECHNICAL FIELD

This disclosure relates to transport of media data, in particular, augmented reality media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The video data may be assembled into a media file conforming to any of a variety of standards, such as the International Organization for Standardization (ISO) base media file format and extensions thereof.

### SUMMARY

In general, this disclosure describes techniques for processing augmented reality (AR) media data or other extended reality (XR) media data. XR media data may include any or all of AR data, mixed reality (MR) data, and/or virtual reality (VR) data. This disclosure generally describes the use of AR data, although any of the various types of XR data may be used in addition or in the alternative. During an AR communication session, a user may be represented by an avatar. The avatar may correspond to a base model. Throughout the AR communication session, the user may move their body, face, hands, or the like. These movements may be tracked by various devices, and this tracked data may be used to animate the base model of the avatar. For example, the avatar may be animated to match movements of the user, facial expressions of the user, poses of the user, or the like.

The animation data may be transmitted in the form of an animation stream. To reduce the size of the animation stream, per techniques of this disclosure, data of the animation stream may be compressed. In particular, joint pose information (also called joint position data) may be compressed per these techniques. For example, the base model may include a collection of bones, where two bones may intersect at a joint. Animation data may be represented as a collection of rotations of the joints. Such rotations may be expressed using quaternions. Per the techniques of this disclosure, a device may perform extraction and compression of quaternions separately, a device may perform hierarchical prediction of joint transforms based on a skeleton hierarchy, a device may perform temporal prediction through coding of difference data (deltas), and/or a device may perform quantization of transform components.

In one example, a method of decoding animation data for augmented reality (AR) media data includes: receiving encoded joint position data for a pre-defined skeleton for an avatar to be presented during an AR communication session; decoding the encoded joint position data; and animating the avatar according to the joint position data.

In another example, a device for decoding animation data for augmented reality (AR) media data includes: a memory configured to store an avatar to be presented during an AR communication session; and a processing system implemented in circuitry and configured to: receive encoded joint position data for a pre-defined skeleton for an avatar to be presented during an AR communication session; decode the encoded joint position data; and animate the avatar according to the joint position data.

In another example, a method of encoding animation data for augmented reality (AR) media data includes: receiving joint position information for a pre-defined skeleton for an avatar to be presented during an AR communication session; encoding the joint position information to form encoded joint position information; and sending the encoded joint position information to another device participating in the AR communication session.

In another example, a device for encoding animation data for augmented reality (AR) media data includes: a memory configured to store an avatar to be presented during an AR communication session; and a processing system implemented in circuitry and configured to: receive joint position information for a pre-defined skeleton of the avatar; encode the joint position information to form encoded joint position information; and send the encoded joint position information to another device participating in the AR communication session.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform split rendering techniques.

FIG. 3 is a flow diagram illustrating an example avatar animation workflow that may be used during an augmented reality (AR) session.

FIG. 4 is a flow diagram illustrating an example AR session between two user equipment (UE) devices and a shared space server device.

FIG. 5 is a block diagram illustrating an example user equipment (UE).

FIG. 6 is a block diagram illustrating an example set of devices that may perform various aspects of the techniques of this disclosure.

FIG. 7 is a conceptual diagram illustrating an example set of data that may be used in an AR session per techniques of this disclosure.

FIG. 8 is a conceptual diagram illustrating an example avatar including a skeleton made up of bones and joints.

FIG. 9 is a hierarchy of joints and bones corresponding to the example skeleton of FIG. 8.

FIG. 10 is a conceptual diagram illustrating an example graph of joint nodes connected to each other by bones.

FIG. 11 is a conceptual diagram illustrating vertex weighting for particular bones of a skeleton.

FIG. 12 is a block diagram illustrating an example set of components of an animation compression unit per techniques of this disclosure.

FIG. 13 is a block diagram illustrating an example animation decompression unit per techniques of this disclosure.

FIG. 14 is a flowchart illustrating an example method of encoding joint position data for a skeleton of an avatar per techniques of this disclosure.

FIG. 15 is a flowchart illustrating an example method of decoding joint position data for a skeleton of an avatar per techniques of this disclosure.

### DETAILED DESCRIPTION

In general, this disclosure describes techniques for transporting and processing extended reality (XR) media data, such as augmented reality (AR) media data, mixed reality (MR) media data, or virtual reality (VR) media data. Immersive AR experiences are based on shared virtual spaces, where people (represented by avatars) join and interact with each other and the environment. Avatars may be realistic representations of the user or may be a “cartoonish” representation. Avatars may be animated to mimic the user's body pose and facial expressions. Each user participating in an AR communication session may share a pre-recorded base avatar model with other participants, where the base avatar models may be animated during the AR communication session to represent movements of the corresponding user.

A display device (or another device) may capture facial movements of the user. For example, the display device may include one or more cameras or other sensors for detecting facial expressions and/or movements of the user, e.g., smiling, neutral, frowning, or mouth and jaw movements that occur when the user speaks. The display device may encode data representative of such facial movements and send the encoded data to a receiving device, such that the receiving device can animate the user's avatar consistent with the user's facial movements.

A receiving device may render received AR media data. Such rendering may be performed on a single device or using split rendering. A split rendering server may perform at least part of a rendering process to form rendered images, then stream the rendered images to a display device, such as AR glasses or a head mounted display (HMID). In general, a user may wear the display device, and the display device may capture pose information, such as a user position and orientation/rotation in real world space, which may be translated to render images for a viewport in a virtual world space.

By encoding and decoding animation data using any of the various techniques of this disclosure, a bitrate of a bitstream sent as part of an AR media communication session may be reduced. Thus these techniques may reduce bandwidth used to transmit AR media data as part of the AR media communication session. Likewise, these techniques may reduce latency for AR media communication sessions through reduction of the bitrate.

Split rendering may enhance a user experience through providing access to advanced and sophisticated rendering that otherwise may not be possible or may place excess power and/or processing demands on AR glasses or a user equipment (UE) device. In split rendering all or parts of the three-dimensional (3D) scene are rendered remotely on an edge application server, also referred to as a “split rendering server” in this disclosure. The results of the split rendering process are streamed down to the UE or AR glasses for display. The spectrum of split rendering operations may be wide, ranging from full pre-rendering on the edge to offloading partial, processing-extensive rendering operations to the edge.

The display device (e.g., UE/AR glasses) may stream pose predictions to the split rendering server at the edge. The display device may then receive rendered media for display from the split rendering server. The AR runtime may be configured to receive rendered data together with associated pose information (e.g., information indicating the predicted pose for which the rendered data was rendered) for proper composition and display. For instance, the AR runtime may need to perform pose correction to modify the rendered data according to an actual pose of the user at the display time.

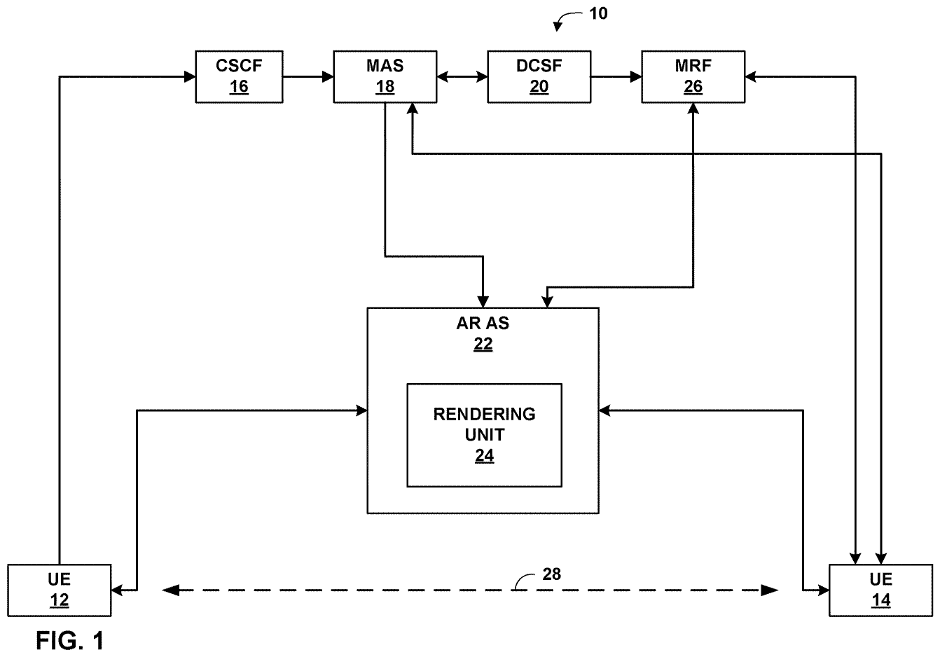

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (MRF) 26, and augmented reality application server (AR AS) 22. MAS 18 may correspond to a multimedia telephony application server, an IP Multimedia Subsystem (IMS) application server, or the like.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects. The users may be represented by avatars, which may be realistic or cartoonish depictions of the users in the virtual AR scene. The users may interact with virtual objects, which may cause the virtual objects to move or trigger other behaviors in the virtual scene. Furthermore, the users may navigate through the virtual scene, and a user's corresponding avatar may move according to the user's movements or movement inputs. In some examples, the users' avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or a serving CSCF (S-CSCF). CSCF 16 may generally authenticate users of UEs 12 and/or 14, inspect signaling for proper use, provide quality of service (QoS), provide policy enforcement, participate in session initiation protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session. MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in an audio-visual communication sessions. Based on this data, MRF 26 may create a scene that defines placement of each user and AR media in the scene (e.g., position, size, depth from the user, anchor type, and recommended resolution/quality); and specific rendering properties for AR media data (e.g., if two-dimensional (2D) media should be rendered with a “billboarding” effect such that the 2D media is always facing the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a PC, laptop, tablet, or cellular phone of a user, and UE 14 may correspond to a wireless display device, e.g., AR/VR/MR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchanges media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

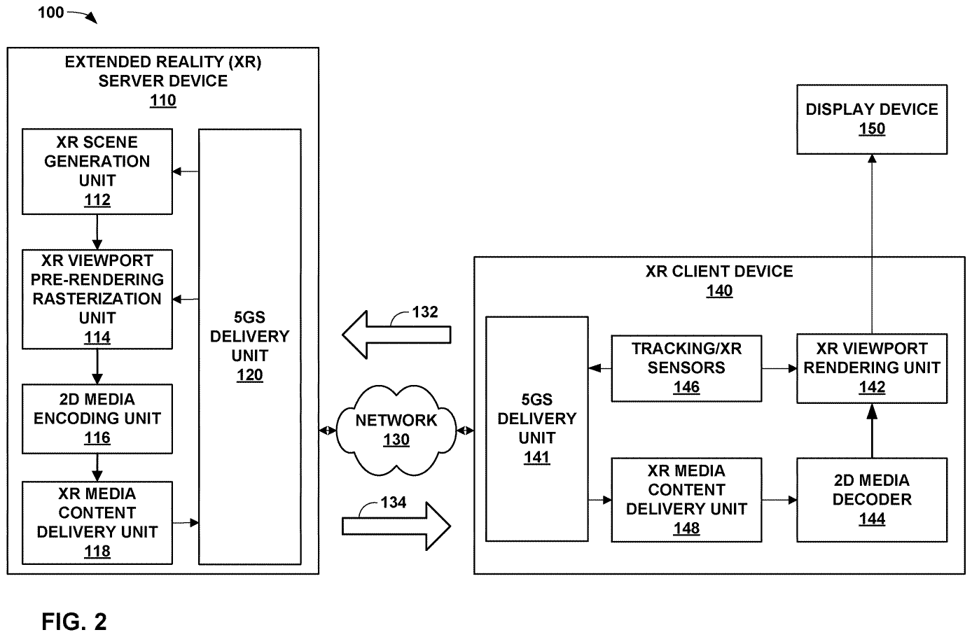

FIG. 2 is a block diagram illustrating an example computing system 100 that may perform split rendering techniques. In this example, computing system 100 includes extended reality (XR) server device 110, network 130, XR client device 140, and display device 150. XR server device 110 includes XR scene generation unit 112, XR viewport pre-rendering rasterization unit 114, 2D media encoding unit 116, XR media content delivery unit 118, and 5G System (5GS) delivery unit 120.

Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. For example, network 130 may represent a wireless or wired local network. In other examples, XR client device 140 and XR server device 110 may communicate via other mechanisms, such as Bluetooth, a wired universal serial bus (USB) connection, or the like. XR client device 140 includes 5GS delivery unit 141, tracking/XR sensors 146, XR viewport rendering unit 142, 2D media decoder 144, and XR media content delivery unit 148. XR client device 140 also interfaces with display device 150 to present XR media data to a user (not shown).

In some examples, XR scene generation unit 112 may correspond to an interactive media entertainment application, such as a video game, which may be executed by one or more processors implemented in circuitry of XR server device 110. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 141. XR client device 140 provides tracking and sensor information 132 to XR server device 110 via network 130. XR server device 110, in turn, receives tracking and sensor information 132 and provides this information to XR scene generation unit 112 and XR viewport pre-rendering rasterization unit 114. In this manner, XR scene generation unit 112 can generate scene data for the user's viewport and location, and then pre-render 2D media data for the user's viewport using XR viewport pre-rendering rasterization unit 114. XR server device 110 may therefore deliver encoded, pre-rendered 2D media data 134 to XR client device 140 via network 130, e.g., using a 5G radio configuration.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular encoder/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 2, the viewport is predominantly rendered in XR server device 110, but XR client device 140 is able to do latest pose correction, for example, using asynchronous time-warping or other XR pose correction to address changes in the pose. XR graphics workload may be split into rendering workload on a powerful XR server device 110 (in the cloud or the edge) and pose correction (such as asynchronous timewarp (ATW)) on XR client device 140. Low motion-to-photon latency is preserved via on-device Asynchronous Time Warping (ATW) or other pose correction methods performed by XR client device 140.

The various components of XR server device 110, XR client device 140, and display device 150 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

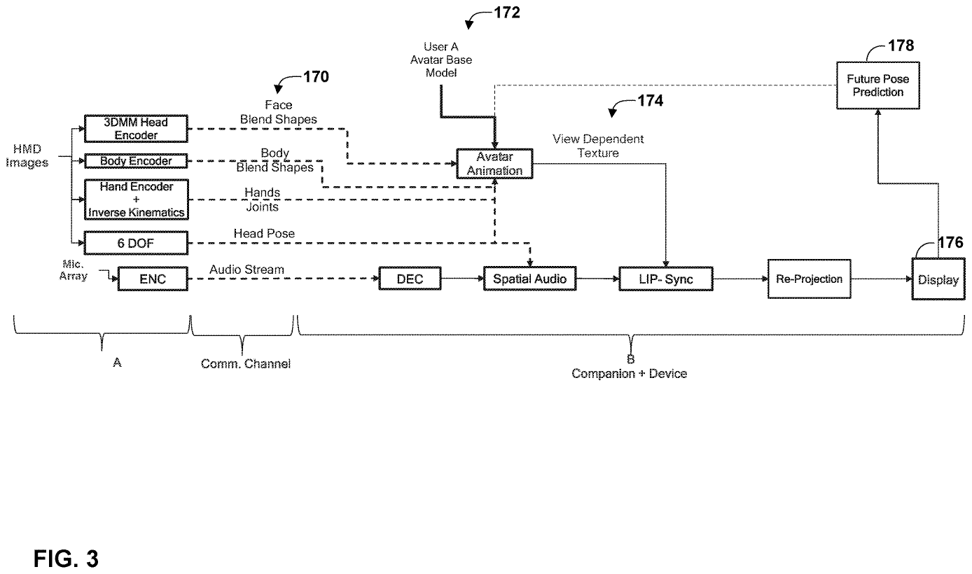

FIG. 3 is a flow diagram illustrating an example avatar animation workflow that may be used during an AR session. In this example, received animation stream data 170 includes face blend shapes, body blend shapes, hand joints, head pose, and audio stream data. The face blend shapes, body blend shapes, and hand joints may correspond to animation streams to be applied to user A avatar base model 172. In particular, data for user A avatar base model 172 may be stored at various levels of detail, per the techniques of this disclosure. Thus, rendering components 174 may retrieve data of user A avatar base model 172 at an appropriate level of detail, e.g., based on a distance between a current user and user A in a 3D space. Rendering components 174 may then animate the avatar base model using received animation stream data 170. Ultimately, the animated avatar base model may be presented to the current user via display 176. In addition, movement data of the current user may be used to predict a future pose of the user by future pose prediction unit 178.

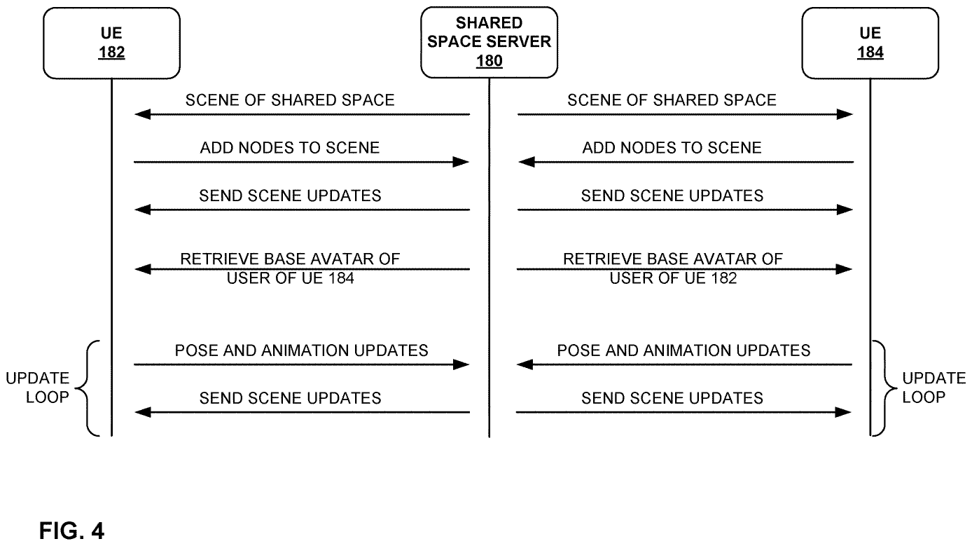

FIG. 4 is a flow diagram illustrating an example AR session between two user equipment (UE) devices and a shared space server device. As shown in the example of FIG. 4, two or more UEs (e.g., UEs 182, 184) may participate in an AR session. UE 184 may retrieve a base avatar of a user of UE 182 from shared space server 180 (or a separate digital avatar repository), and UE 182 may retrieve a base avatar of a user of UE 184 from shared space server 180 (or a separate digital avatar repository). UEs 182, 184 may send and receive data representative of their animation streams and other 3D model data to and from a shared space server. For example, various sensors such as cameras, trackers, light detection and ranging (LIDAR), or the like, may track user movements, such as facial movements (e.g., during speech or as emotional reactions), hand movements, walking movements, or the like. These movements may be translated into an animation stream by, e.g., UE 182 and sent to shared space server 180. Shared space server 180 may then send the animation stream to UE 184.

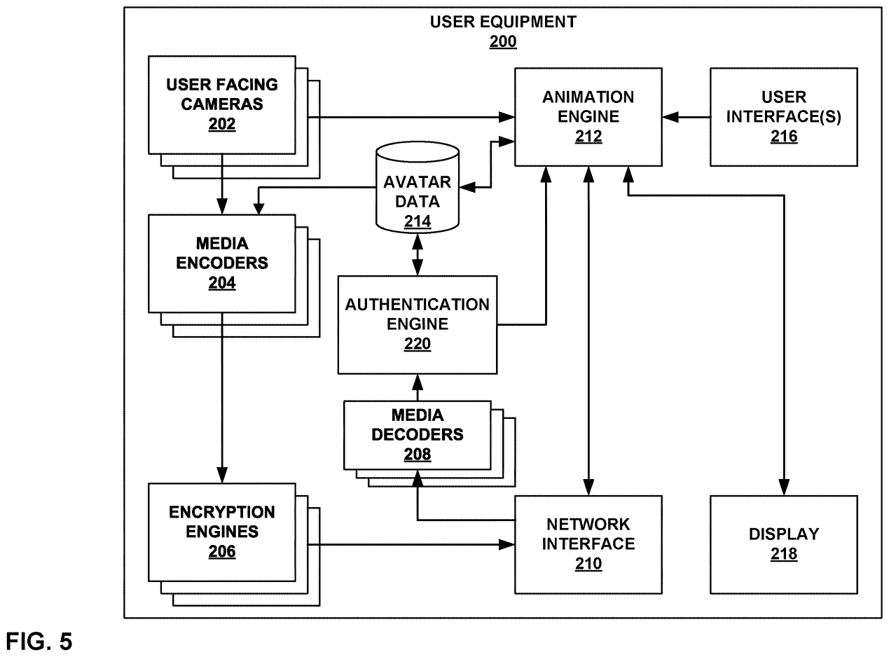

FIG. 5 is a block diagram illustrating an example user equipment (UE) 200. UEs 12, 14 of FIG. 1 may include components similar to those of UE 200. In general, a participant device may both send and receive content during an AR communication session. In this example, UE 200 includes user facing cameras 202, media encoders 204, encryption engines 206, media decoders 208, network interface 210, authentication engine 220, avatar data 214, animation engine 212, user interface(s) 216, and display 218.

A user may use UE 200 to participate in an AR communication session, e.g., to both send and receive AR data with one or more other participants in the AR communication session. For example, UE 200 may receive inputs from the user via user interface(s) 216, which may correspond to buttons, controllers, track pads, joysticks, keyboards, sensors, or the like. Such inputs may represent, for example, movements of the user in real-world space to be translated into the virtual scene, such as locomotive movement, head movements, eye movements (captured by user facing cameras 202), or interactions with the various buttons or other interface devices.

Animation engine 212 may receive such inputs and determine how to animate a user's avatar, stored in avatar data 214. For example, such animations may include locomotive animations (walking or running), arm movement animations, hand movement animations, finger movement animations, and/or facial expression change animations. Animation engine 212 may provide animation information to network interface 210 for output to other participants in the AR communication session, along with other information such as, for example, interactions with virtual objects, movement direction, viewport, or the like.

In addition, per the techniques of this disclosure, user facing cameras 202 may provide one or more video streams of a user's face to media encoder(s) 204 to form an encoded video stream, which may be encrypted by encryption engine(s) 206 or sent unencrypted. That is, one or more video streams capturing distinguishing features of the user's face or other objects of interest (e.g., background objects, location-identifying objects, unique identifiers, or the like) may be sent via network interface 210 to one or more other participants in the AR communication session. When the user is wearing a head-mounted display (HMD), the HMD may be configured to capture only parts of the user's face by user-facing cameras 202 of the HMD (e.g., eyes and mouth may be captured as three distinct streams). Such video streams (which may further be encrypted) may be provided to network interface 210 and sent to other participants in the AR communication session, such that the UEs of the other participants can authenticate that the avatar data is actually coming from the user of UE 200, per the techniques of this disclosure. In general, the distinguishing features may be any one or more elements of a person, location, object, or the like that may be used to uniquely identify the target person, location, or object and to associate the avatar (or other 3D object) with the target person, location, or object.

Similarly, UE 200 may receive encrypted video stream(s) from the other participants in the AR communication session. UE 200 may decrypt and then decode the video stream(s) using media decoders 208, which may provide the decrypted video streams to authentication engine 220. Per the techniques of this disclosure, authentication engine 220 may compare data of the received video streams to authentication data associated with an avatar of the other user being authenticated, stored with avatar data 214.

As an example, authentication engine 220 may include a deep learning algorithm, e.g., an artificial intelligence/machine learning (AI/ML) model trained to extract facial features. The facial features may be a vector of values, e.g., 568 values, that provide a latent representation of a face. Distances to the facial features may be stored in the base avatar model as part of avatar data 214. Authentication engine 220 may calculate distances between facial features extracted from the received video bitstream(s) and compare these distances to the distances stored as part of avatar data 214, to determine if the user's face is the same as that of the user associated with the avatar. In addition to, or in the alternative to, facial features, other features may be used, such as 3D head features, vocal features, and/or light environments.

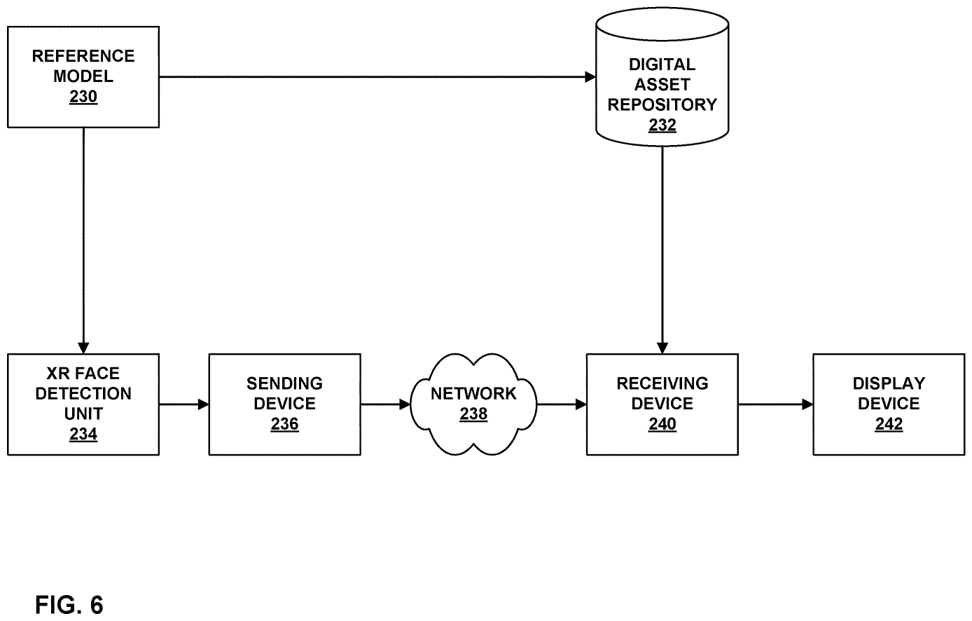

FIG. 6 is a block diagram illustrating an example set of devices that may perform various aspects of the techniques of this disclosure. The example of FIG. 6 depicts reference model 230, digital asset repository 232, XR face detection unit 234, sending device 236, network 238, receiving device 240, and display device 242. Sending device 236 may correspond to UE 12 of FIG. 1, and receiving device 240 may correspond to UE 14 of FIG. 1 and/or XR client device 140 of FIG. 2.

Sending device 236 and receiving device 240 may represent user equipment (UE) devices, such as smartphones, tablets, laptop computers, personal computers, or the like. XR face detection unit 234 may be included in an AR display device, such as an AR headset, which may be communicatively coupled to sending device 236. Likewise, display device 242 may be an AR display device, such as an AR headset.

In this example, reference model 230 includes model data for a human body and face. Digital asset repository 232 may include avatar data for a user, e.g., a user of sending device 236. Digital asset repository 232 may store the avatar data in a base avatar format. The base avatar format may differ based on software used to form the base avatar, e.g., modeling software from various vendors.

XR face detection unit 234 may detect facial expressions of a user and provide data representative of the facial expressions to sending device 236. Sending device 236 may encode the facial expression data and send the encoded facial expression data to receiving device 240 via network 238. Network 238 may represent the Internet or a private network (e.g., a virtual private network (VPN)). Receiving device 240 may decode and reconstruct the facial expression data and use the facial expression data to animate the avatar of the user of sending device 236.

Various facial and body tracking units may perform facial and body tracking in different ways, which may vary widely according to a solution being sought. For example, various facial and body tracking units may be configured with different numbers of blendshapes with different sets of expressions and/or different rigs (that is, 3D models of joints and bones) with different sets of bones and joints and different bone dimension. Some facial expressions and bones/joints do not exist in certain solutions but do exist in other solutions.

This variation in 3D object model representations can lead to interoperability challenges. For example, sending device 236 may use a first framework to track face and body movements of a user, while receiving device 240 may use a base avatar of the user of sending device 236 that is based on a different set of facial expressions and body skeleton. This disclosure describes techniques for enabling avatar animation when different tracking frameworks are used for the base model and movement tracking.

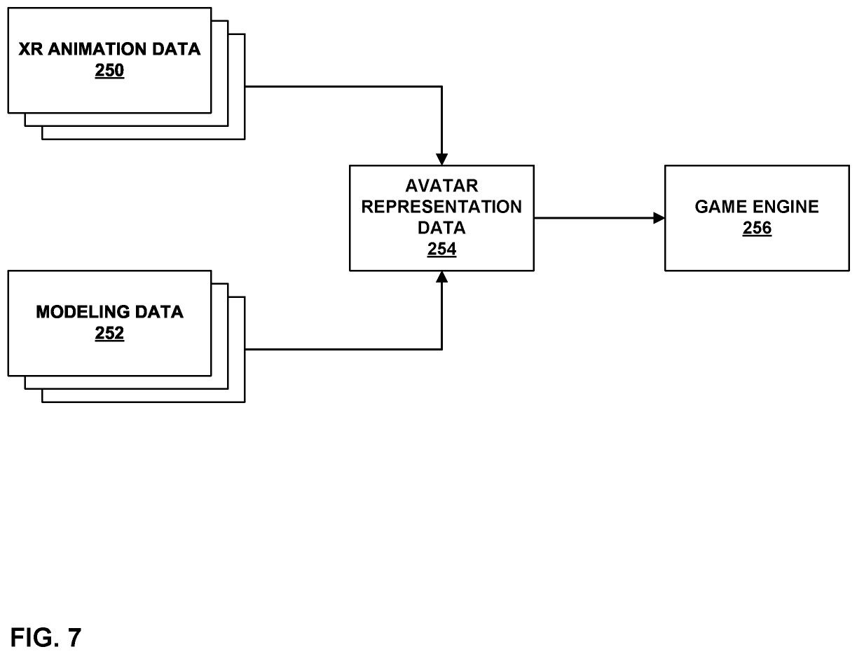

FIG. 7 is a conceptual diagram illustrating an example set of data that may be used in an AR session per techniques of this disclosure. In this example, FIG. 7 depicts XR animation data 250, modeling data 252, avatar representation data 254, and game engine 256. Modeling data 252 may represent one or more sets of data used to form a base avatar model, which may originate from various sources, such as modeling software (e.g., Blender or Maya), GL Transmission Format (glTF), universal scene description (USD), Virtual Reality Model (VRM) Consortium, MetaHuman, or the like. XR animation data 250 may represent one or more tracked movements of a user to be used to animate the base model, which may originate from OpenXR, ARKit, MediaPipe, or the like. The combination of the base model and the animation data may be formed into avatar representation data 254, which game engine 256 may use to display an animated avatar. Game engine 256 may represent Unreal Engine, Unity Engine, Godot Engine, Third Generation Partnership Project (3GPP), or the like.

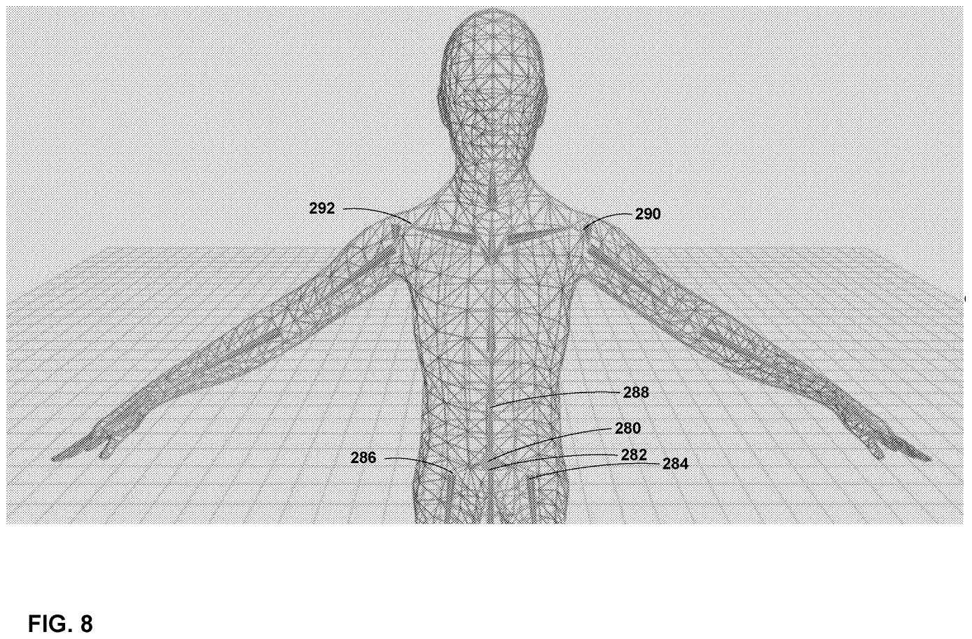

FIG. 8 is a conceptual diagram illustrating an example avatar including a skeleton made up of bones and joints. The image for FIG. 8 is adapted from that available at developers.meta.com/horizon/documentation/native/android/move-ref-body-joints/. In this example, the skeleton includes a variety of bones, including root 280, pelvis 282, left hip 284, right hip 286, spine 288, left collar 290, and right collar 292.

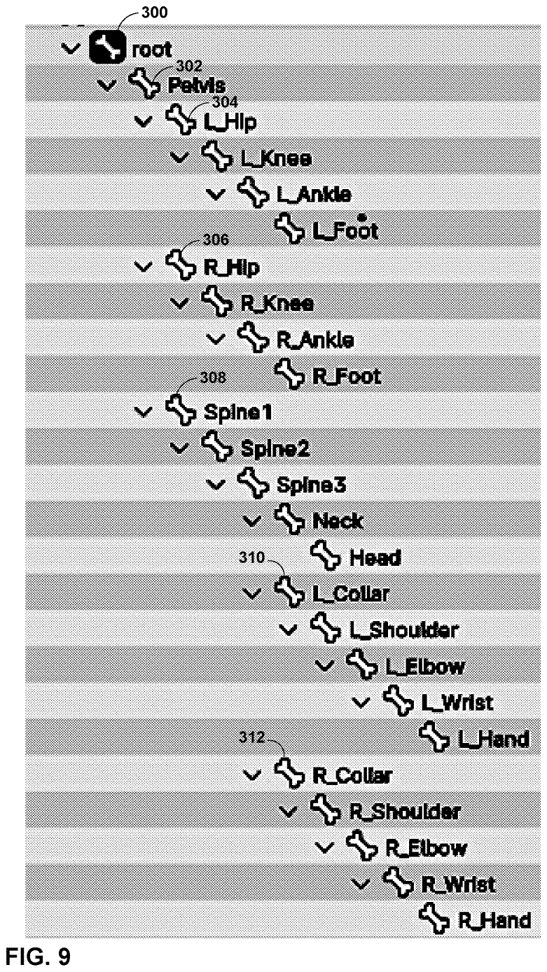

FIG. 9 is a hierarchy of joints and bones corresponding to the example skeleton of FIG. 8. In this example, the hierarchy includes root node 300 corresponding to root 280 of FIG. 8, pelvis node 302 corresponding to pelvis 282 of FIG. 8, left hip node 304 corresponding to left hip 284 of FIG. 8, right hip node 306 corresponding to right hip 286 of FIG. 8, spine node 308 corresponding to spine 288 of FIG. 8, left collar node 310 corresponding to left collar 290 of FIG. 8, and right collar node 312 corresponding to right collar 292 of FIG. 8.

Body animations to be used to animate an avatar may be based on movements of bones of a user skeleton. The skeleton may be characterized as a hierarchy of joints connecting bones that can be translated or rotated, e.g., as shown in FIG. 9. The number of bones and joints may depend on the skeleton being used.

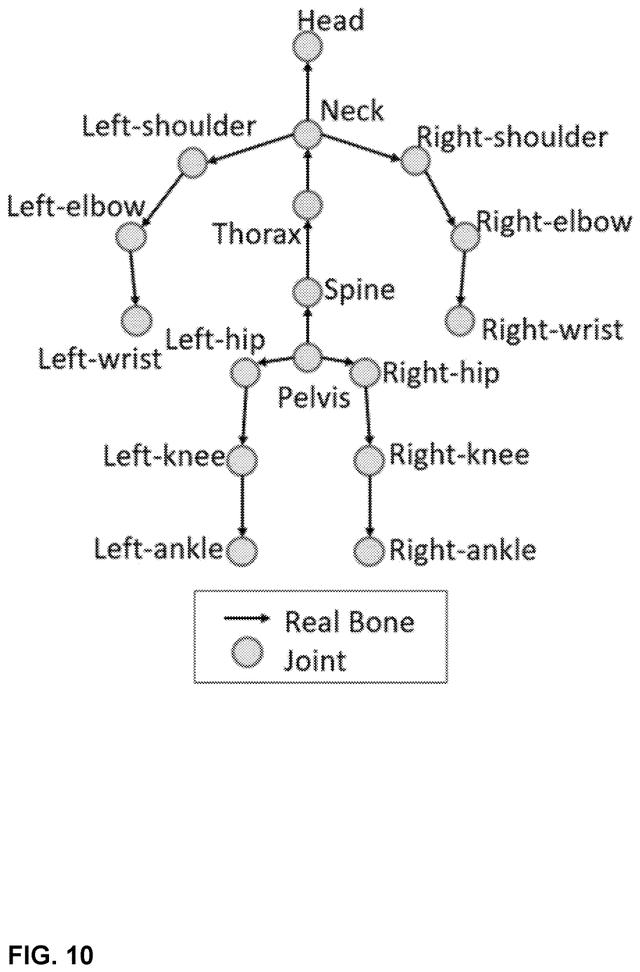

FIG. 10 is a conceptual diagram illustrating an example graph of joint nodes connected to each other by bones. The image for FIG. 10 is adapted from an image included in Wang et al., “Motion Projection Consistency Based 3D Human Pose Estimation with Virtual Bones from Monocular Videos,” 14 Journal of Latex Class Files 8, Aug. 2015, available at arxiv.org/abs/2106.14706.

Body animations that may be applied to a base avatar may be provided as local transformations applied to a rest pose (e.g., a T-pose). Global joint transformations may be computed according to a hierarchical structure proceeding from parent to child nodes, e.g., as shown in FIGS. 9 and 10. That is, as shown in FIG. 9, bones and joints are arranged hierarchically. Likewise, arrows as shown in FIG. 10 may provide a hierarchy for the skeleton, where the arrow head ends at a child node and the arrow starts from a parent node to the child node.

In some examples, movements of certain nodes may impact movements of other nodes that are not directly connected. For example, referring to FIG. 10, shoulder movement may be impacted by each of the pelvis, spine, thorax, and/or neck movements, in addition to direct shoulder movements. Thus, matrix transformations may be used to express movements, e.g., translation, rotation, and scale. For example, shoulder movements may be expressed as follows:

$$global ( shoulder ) = global ( neck ) * local ( shoulder ) = local ( pelvis ) * local ( spine ) * local ( thorax ) * local ( neck ) * local ( shoulder )$$

In some examples, these transformations are represented as 4×4 matrices that combine translation, rotation, and scale components. The system composes these 4×4 matrix transformations to determine the global position of a joint based on the accumulated local transformations of its parent joints.

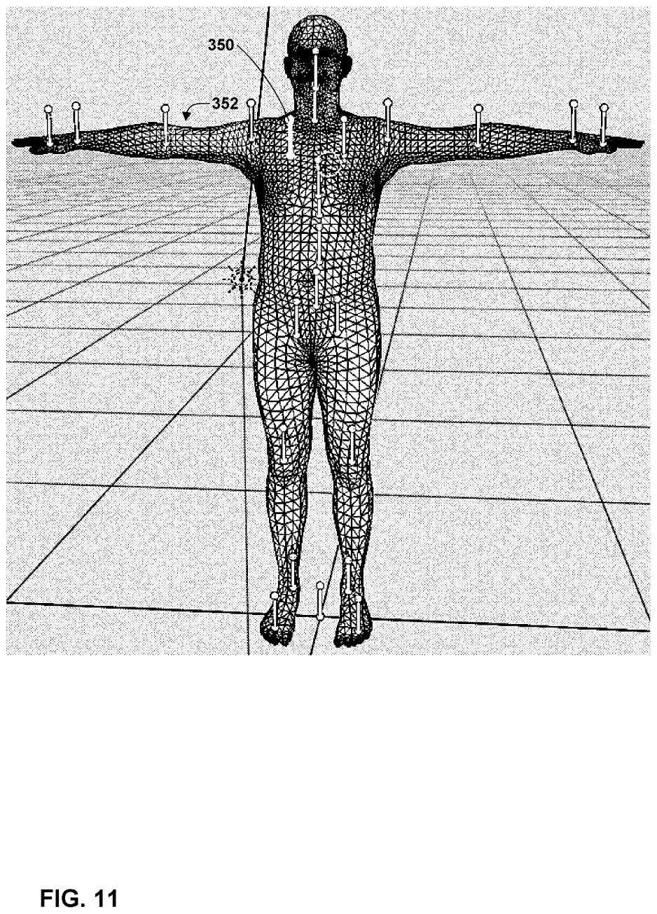

FIG. 11 is a conceptual diagram illustrating vertex weighting for particular bones of a skeleton. Techniques for computing positions of mesh vertices based on joint positions are explained with respect to FIG. 11. Such techniques include linear blend skinning. In linear blend skinning, a vertex of a mesh is influenced by some number of bones, e.g., at most four bones. For a given (vertex, bone) pair, a weight w_{v,b} may be used to express the intensity of influence the bone has on that vertex, e.g., per the following formula:

$${v}_{i}^{′} = {\sum }_{j = 1}^{n} {w}_{i , j} * global ( {bone}_{j} ) * {v}_{i}$$

where v′ᵢ represents a new global coordinate of vertex i, vᵢ represents an original global coordinate of vertex i, w_{i,j} represents an influence of bone j over vertex i, global(boneⱼ) represents a global transformation of bone j, and n represents a total number of bones (e.g., 4) having influence on vertex i.

A user or developer may use a graphical tool to select each bone and indicate an amount of influence that bone has on various vertices. For example, with respect to FIG. 11, the user may select bone 350, then “weight paint” region 352 to indicate a degree of influence movements of bone 350 have over movements of vertices in region 352. Painting the vertices in region 352 with additional force may increase the amount of influence by movements of bone 350, which may be graphically depicted by a heat map that depicts colors from blue to red, where blue colors represent zero or very little influence, red colors represent high influence, and colors between blue and red (e.g., green, yellow, and orange) represent increasingly higher influence from blue to red.

This disclosure recognizes that animation data may be significant in size, depending on a frequency and number of joints and bones. Bitrates of 6-7 Mbps are typical when conventionally transmitting raw OpenXR tracking data. Thus, the techniques of this disclosure may be used to compress joint animation samples, thereby decreasing bitrates for animation streams.

The animation data may be packetized for transport via the network. Beyond the actual joint transforms, the animation stream incurs overhead from transport headers, such as Internet Protocol (IP) headers, User Datagram Protocol (UDP) headers, and Data Channel headers. Furthermore, the animation payload itself may include fixed headers per frame that contribute to the data volume. For example, facial animation parameters may include a timestamp, a blendshape set identifier, validity flags, and/or a count of blendshapes. Similarly, body joint parameters may include timestamps, joint set identifiers, flags indicating if velocity data is present, and specific joint counts. Hand and eye tracking data may similarly include headers, counts, and validity flags. These overheads, combined with high-frequency sampling (e.g., 60 Hz to 120 Hz) and the large number of joints typically tracked in a skeleton, contribute to the high bandwidth requirements addressed by the compression techniques described herein.

In one example, a framerate be 100 frames per second. Facial animation parameters may occupy approximately 433 bytes per sample. Body joint parameters, including the fixed header and joint size, may occupy approximately 4493 bytes per sample. Hand joint parameters may occupy approximately 1677 bytes per sample. When aggregated with transport overheads, such as IPv4 headers (e.g., 20 bytes), UDP headers (e.g., 8 bytes), and SCTP/DTLS headers (e.g., 36 bytes), the total packet size for body data alone may exceed 4500 bytes per frame, driving the high bandwidth consumption typically observed in raw OpenXR tracking data transmission.

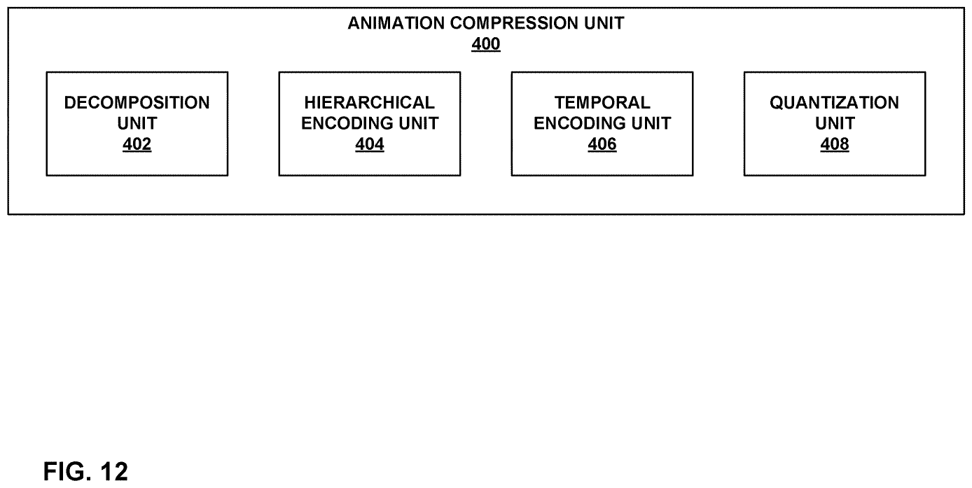

FIG. 12 is a block diagram illustrating an example set of components of an animation compression unit 400 per techniques of this disclosure. Animation compression unit 400 may correspond to one of media encoders 204 of FIG. 5. In general, animation compression unit 400 may compress an animation stream per any or all of the various techniques of this disclosure, alone or in any combination. In particular, animation compression unit 400 includes decomposition unit 402, hierarchical encoding unit 404, temporal encoding unit 406, and quantization unit 408.

In particular, per techniques of this disclosure, animation compression unit 400 of FIG. 5 may perform a compression scheme for joint pose information. For example, animation compression unit 400 may perform extraction and compression of quaternions separately. Additionally or alternatively, animation compression unit 400 may perform hierarchical prediction of joint transforms based on a skeleton hierarchy. Additionally or alternatively, animation compression unit 400 may perform temporal prediction through coding of differences (deltas), e.g., between positions of joints over time. Additionally or alternatively, animation compression unit 400 may quantize transform components.

In some examples, decomposition unit 402 of animation compression unit 400 may decompose rotation and scale values for joints of a skeleton for an animation stream. In general, decomposition unit 402 may extract rotation and scale components from a transform matrix M. Decomposition unit 402 may extract scale values sₓ, s_{y}, and s_{z} according to the following formulas:

$${s}_{x} = \sqrt{{M}_{11}^{2} + {M}_{21}^{2} + {M}_{31}^{2}}$$

$${s}_{y} = \sqrt{{M}_{12}^{2} + {M}_{22}^{2} + {M}_{32}^{2}}$$

$${s}_{z} = \sqrt{{M}_{13}^{2} + {M}_{23}^{2} + {M}_{33}^{2}}$$

Decomposition unit 402 may then extract rotation value Rᵢⱼ according to

$${R}_{i j} = \frac{{M}_{i j}}{{s}_{j}} .$$

Decomposition unit 402 may then convert rotation to a Quaternion value as follows:

$$trace = {R}_{11} + {R}_{22} + {R}_{33}$$

$$s = 0.5 / \sqrt{trace + 1.}$$

$$w = 0.25 / s$$

$$x = ( {R}_{32} - {R}_{23} ) \times s$$

$$y = ( {R}_{13} - {R}_{31} ) \times s$$

$$z = ( {R}_{21} - {R}_{12} ) \times s$$

Decomposition unit 402 may then compress three of four components of the quaternion. That is, the quaternion may be expressed by components w, x, y, and z. Based on the observation that w²+x²+y²+z²=1, decomposition unit 402 may remove the largest component qₘₐₓ from w, x, y, and z. Qₘₐₓ may be calculated (e.g., by one or more of media decoders 208 configured as an animation decompression/decoding unit) according to the following formula:

$${q}_{max} = \sqrt{1 - {q}_{1}^{2} - {q}_{2}^{2} - {q}_{3}^{2}}$$

Additionally or alternatively, hierarchical encoding unit 404 of animation compression unit 400 may exploit redundancies in transform matrix T of a joint and a parent joint to the joint. Hierarchical encoding unit 404 may convert T_{world} of joint j to T_{local} of joint j as follows:

$${T}_{j}^{local} = {( {T}_{p}^{world} )}^{- 1} \times {T}_{j}^{world}$$

An animation decompression unit (e.g., one or more of media decoders 208 configured as an animation decompression/decoding unit) may decode the transform matrix T by converting T_{local} back to T_{world} for joint j as follows:

$${T}_{j}^{world} = {T}_{p}^{world} \times {T}_{j}^{local}$$

Encoding and decoding of transform matrices may be performed hierarchically from root joints to leaf joints, e.g., as shown in FIGS. 9 and 10. One example hierarchy of joints for body tracking is expressed below, where “M: N” indicates that joint node M is a child of joint node N:

### # Main Body Trunk

0: −1, # XR_BODY_JOINT_ROOT_FB (root)
1: 0, # XR_BODY_JOINT_HIPS_FB
2: 1, # XR_BODY_JOINT_SPINE_LOWER_FB
3: 2, # XR_BODY_JOINT_SPINE_MIDDLE_FB
4: 3, # XR_BODY_JOINT_SPINE_UPPER_FB
5: 4, # XR_BODY_JOINT_CHEST_FB
6: 5, # XR_BODY_JOINT_NECK_FB
7: 6, # XR_BODY_JOINT_HEAD_FB

### # Left Arm and Shoulder

8: 5, # XR_BODY_JOINT_LEFT_SHOULDER_FB
9: 8, # XR_BODY_JOINT_LEFT_SCAPULA_FB
10: 8, # XR_BODY_JOINT_LEFT_ARM_UPPER_FB
11: 10, # XR_BODY_JOINT_LEFT_ARM_LOWER_FB
12: 11, # XR_BODY_JOINT_LEFT_HAND_WRIST_TWIST_FB

### # Right Arm and Shoulder

13: 5, # XR_BODY_JOINT_RIGHT_SHOULDER_FB
14: 13, # XR_BODY_JOINT_RIGHT_SCAPULA_FB
15: 13, # XR_BODY_JOINT_RIGHT_ARM_UPPER_FB
16: 15, # XR_BODY_JOINT_RIGHT_ARM_LOWER_FB
17: 16, # XR_BODY_JOINT_RIGHT_HAND_WRIST_TWIST_FB

### # Left Hand

18: 12, # XR_BODY_JOINT_LEFT_HAND_PALM_FB
19: 12, # XR_BODY_JOINT_LEFT_HAND_WRIST_FB

### # Left Thumb

20: 19, # XR_BODY_JOINT_LEFT_HAND_THUMB_METACARPAL_FB
21: 20, # XR_BODY_JOINT_LEFT_HAND_THUMB_PROXIMAL_FB
22: 21, # XR_BODY_JOINT_LEFT_HAND_THUMB_DISTAL_FB
23: 22, # XR_BODY_JOINT_LEFT_HAND_THUMB_TIP_FB

### # Left Index Finger

24: 19, # XR_BODY_JOINT_LEFT_HAND_INDEX_METACARPAL_FB
25: 24, # XR_BODY_JOINT_LEFT_HAND_INDEX_PROXIMAL_FB
26: 25, # XR_BODY_JOINT_LEFT_HAND_INDEX_INTERMEDIATE_FB
27: 26, # XR_BODY_JOINT_LEFT_HAND_INDEX_DISTAL_FB
28: 27, # XR_BODY_JOINT_LEFT_HAND_INDEX_TIP_FB

### # Left Middle Finger

29: 19, # XR_BODY_JOINT_LEFT_HAND_MIDDLE_METACARPAL_FB
30: 29, # XR_BODY_JOINT_LEFT_HAND_MIDDLE_PROXIMAL_FB
31: 30, # XR_BODY_JOINT_LEFT_HAND_MIDDLE_INTERMEDIATE_FB
32: 31, # XR_BODY_JOINT_LEFT_HAND_MIDDLE_DISTAL_FB
33: 32, # XR_BODY_JOINT_LEFT_HAND_MIDDLE_TIP_FB

### # Left Ring Finger

34: 19, # XR_BODY_JOINT_LEFT_HAND_RING_METACARPAL_FB
35: 34, # XR_BODY_JOINT_LEFT_HAND_RING_PROXIMAL_FB
36: 35, # XR_BODY_JOINT_LEFT_HAND_RING_INTERMEDIATE_FB
37: 36, # XR_BODY_JOINT_LEFT_HAND_RING_DISTAL_FB
38: 37, # XR_BODY_JOINT_LEFT_HAND_RING_TIP_FB

### # Left Little Finger

39: 19, # XR_BODY_JOINT_LEFT_HAND_LITTLE_METACARPAL_FB
40: 39, # XR_BODY_JOINT_LEFT_HAND_LITTLE_PROXIMAL_FB
41: 40, # XR_BODY_JOINT_LEFT_HAND_LITTLE_INTERMEDIATE_FB
42: 41, # XR_BODY_JOINT_LEFT_HAND_LITTLE_DISTAL_FB
43: 42, # XR_BODY_JOINT_LEFT_HAND_LITTLE_TIP_FB

### # Right Hand

44: 17, # XR_BODY_JOINT_RIGHT_HAND_PALM_FB
45: 17, # XR_BODY_JOINT_RIGHT_HAND_WRIST_FB

### # Right Thumb

46: 45, # XR_BODY_JOINT_RIGHT_HAND_THUMB_METACARPAL_FB
47: 46, # XR_BODY_JOINT_RIGHT_HAND_THUMB_PROXIMAL_FB
48: 47, # XR_BODY_JOINT_RIGHT_HAND_THUMB_DISTAL_FB
49: 48, # XR_BODY_JOINT_RIGHT_HAND_THUMB_TIP_FB

### # Right Index Finger

50: 45, # XR_BODY_JOINT_RIGHT_HAND_INDEX_METACARPAL_FB
51: 50, # XR_BODY_JOINT_RIGHT_HAND_INDEX_PROXIMAL_FB
52: 51, # XR_BODY_JOINT_RIGHT_HAND_INDEX_INTERMEDIATE_FB
53: 52, # XR_BODY_JOINT_RIGHT_HAND_INDEX_DISTAL_FB
54: 53, # XR_BODY_JOINT_RIGHT_HAND_INDEX_TIP_FB

### # Right Middle Finger

55: 45, # XR_BODY_JOINT_RIGHT_HAND_MIDDLE_METACARPAL_FB
56: 55, # XR_BODY_JOINT_RIGHT_HAND_MIDDLE_PROXIMAL_FB
57: 56, # XR_BODY_JOINT_RIGHT_HAND_MIDDLE_INTERMEDIATE_FB
58: 57, # XR_BODY_JOINT_RIGHT_HAND_MIDDLE_DISTAL_FB
59: 58, # XR_BODY_JOINT_RIGHT_HAND_MIDDLE_TIP_FB

### # Right Ring Finger

60: 45, # XR_BODY_JOINT_RIGHT_HAND_RING_METACARPAL_FB
61: 60, # XR_BODY_JOINT_RIGHT_HAND_RING_PROXIMAL_FB
62: 61, # XR_BODY_JOINT_RIGHT_HAND_RING_INTERMEDIATE_FB
63: 62, # XR_BODY_JOINT_RIGHT_HAND_RING_DISTAL_FB
64: 63, # XR_BODY_JOINT_RIGHT_HAND_RING_TIP_FB

### # Right Little Finger

65: 45, # XR_BODY_JOINT_RIGHT_HAND_LITTLE_METACARPAL_FB
66: 65, # XR_BODY_JOINT_RIGHT_HAND_LITTLE_PROXIMAL_FB
67: 66, # XR_BODY_JOINT_RIGHT_HAND_LITTLE_INTERMEDIATE_FB
68: 67, # XR_BODY_JOINT_RIGHT_HAND_LITTLE_DISTAL_FB
69: 68, # XR_BODY_JOINT_RIGHT_HAND_LITTLE_TIP_FB

Additionally or alternatively, temporal encoding unit 406 of animation compression unit 400 may be configured to perform temporal encoding. Temporal encoding may be optional and, thus, may be disabled, e.g., for non-reliable transport. To perform temporal encoding, temporal encoding unit 406 may calculate differences (deltas) for translation, rotation, and scale values for successive body positions over time as follows:
Translation:

$${t}_{delta} = {R}_{prev}^{T} \times ( {t}_{curr} - {t}_{prev} )$$

Apply rotation before calculating delta
Rotation: delta calculated on quaternions:

$${q}_{delta} = {q}_{prev}^{- 1} \times {q}_{curr}$$

Scale:

$${s}_{delta} = \frac{{s}_{curr}}{{s}_{prev}}$$

Decompression (e.g., performed by one or more of media decoders 208 configured as an animation decompression/decoding unit) may be performed as follows:

$${q}_{curr} = {q}_{prev} \times {q}_{delta}$$

$${t}_{curr} = {t}_{prev} + {R}_{prev} \times {t}_{delta}$$

$${s}_{curr} = {s}_{prev} \times {s}_{delta}$$

Additionally or alternatively, quantization unit 408 of animation compression unit 400 may perform quantization of various components (e.g., translation, rotation, and/or scale). In some examples, each component is expressed using the same number of bits (b). As an example, quantization unit 408 may calculate a quantized value i of a component as follows:

$$i = ( \frac{v - {v}_{min}}{{v}_{max} - {v}_{min}} \times ( {2}^{b} - 1 ) ) ,$$

where b represents a number of bits allocated to component v.

While the example above uses a uniform bit depth (b) for all components for simplicity of description, in other examples, different components may be allocated different numbers of bits. For example, rotation components (quaternions) may be more sensitive to visual artifacts and may be allocated a higher number of bits (e.g., 16 bits) compared to scale components (e.g., 8 bits) or translation components. Similarly, the hierarchical level of a joint may influence bit allocation. Root nodes or parent nodes having a larger impact on the global position of child nodes may be quantized with higher precision (a larger value for b) than leaf nodes, such as finger joints. The value of b may be signaled in a sequence header or determined adaptively based on the specific joint or component type being processed.

Decompression (e.g., performed by one of media decoders 208 configured as an animation decompression/decoding unit) may be performed as follows:

$${v}^{′} = \frac{i}{{2}^{b} - 1} \times ( {v}_{max} - {v}_{min} ) + {v}_{min}$$

While the hierarchy above details body and hand joints, the techniques of this disclosure are similarly applicable to eye joints. For example, a hierarchy including eye joints (e.g., left eye ball, right eye ball) may be subjected to the same hierarchical prediction, quaternion compression, and quantization techniques described herein. The system may compress animation data for body joints, hand joints, and eye joints to reduce the bandwidth required for the augmented reality communication session.

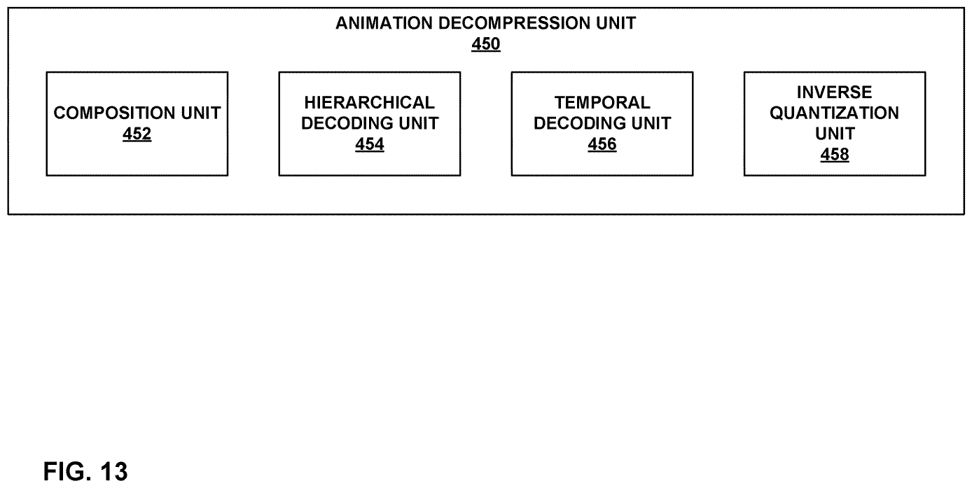

FIG. 13 is a block diagram illustrating an example animation decompression unit 450 per techniques of this disclosure. In this example, animation decompression unit 450 includes composition unit 452, hierarchical decoding unit 454, temporal decoding unit 456, and inverse quantization unit 458. Animation decompression unit 450 may correspond to one of media decoders 208 of FIG. 5.

Composition unit 452 may receive values for three of four quaternion components representing rotation applied to a joint of a skeleton. Composition unit 452 may then calculate a value for the final quaternion component (assumed to be the maximum value among the quaternion components) as follows:

$${q}_{max} = \sqrt{1 - {q}_{1}^{2} - {q}_{2}^{2} - {q}_{3}^{2}}$$

Hierarchical decoding unit 454 may be configured to decode transform matrices for joints from T_{local} to T_{world} for each joint j in hierarchical order as follows:

$${T}_{j}^{world} = {T}_{p}^{world} \times {T}_{j}^{local}$$

where p represents a parent joint to joint j in the skeleton hierarchy.

Temporal decoding unit 456 may be configured to decompress temporally encoded joint animation data as follows:

$${q}_{curr} = {q}_{prev} \times {q}_{delta}$$

$${t}_{curr} = {t}_{prev} + {R}_{prev} \times {t}_{delta}$$

$${s}_{curr} = {s}_{prev} \times {s}_{delta}$$

Inverse quantization unit 458 may be configured to inverse quantize components of, e.g., translation, rotation, or scale, as follows:

$${v}^{′} = \frac{i}{{2}^{b} - 1} \times ( {v}_{max} - {v}_{min} ) + {v}_{min}$$

Inverse quantization unit 458 may receive values representing b (number of bits), vₘₐₓ, and vₘᵢₙ in the bitstream, and receive value i for each component to be decoded.

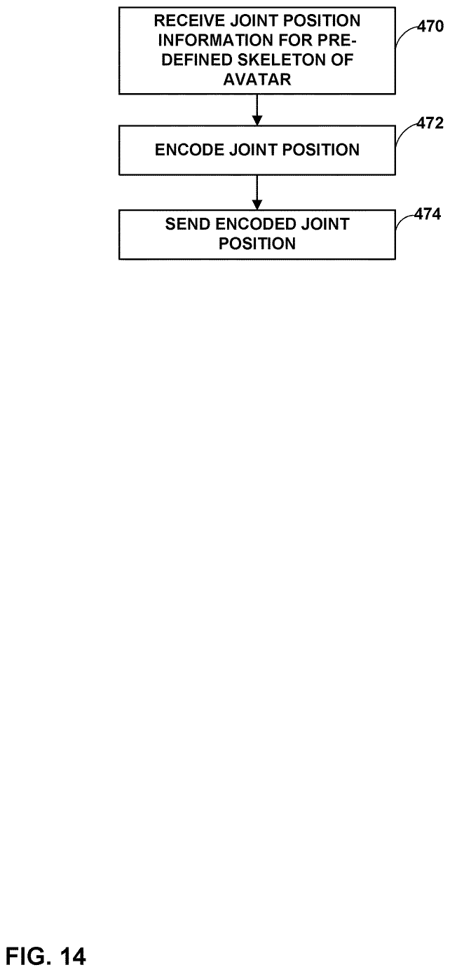

FIG. 14 is a flowchart illustrating an example method of encoding joint position data for a skeleton of an avatar per techniques of this disclosure. One or more processors implemented in circuitry of a device, such as media encoders 204 of UE 200 of FIG. 5, animation compression unit 400 of FIG. 12, UE 12 of FIG. 1, or sending device 236 of FIG. 6, may perform the method of FIG. 14.

The device may initially receive joint position information for a pre-defined skeleton for an avatar to be presented during an AR communication session (470). For example, the device may receive the joint position information from tracking sensors, such as user facing cameras 202 or tracking/XR sensors 146. The joint position information may correspond to a specific hierarchy of bones and joints, such as that shown in FIG. 9.

The device may encode the joint position information to form encoded joint position information (472). In some examples, encoding the joint position information includes performing quaternion compression. The device may determine quaternion component values w, x, y, and z for a quaternion representing rotation of a joint. The device may determine a largest quaternion component (qₘₐₓ) among these values. The device may then encode only the other three components (e.g., q1, q2, and q3), omitting the encoding of qₘₐₓ. The decoder can reconstruct qₘₐₓ based on the property that the sum of the squares of the components equals 1.

Additionally or alternatively, encoding the joint position information may include performing hierarchical encoding. The device may determine an inverse world transform matrix for a parent node p to a current joint node j (represented as inverse of

$${T}_{p}^{world} )$$

and a world transform matrix for the current joint node

$$j ( {T}_{j}^{world} ) .$$

The device may then calculate a local transform matrix for the current joint node j according to

$${T}_{j}^{local} = {( {T}_{p}^{world} )}^{- 1} \times {T}_{j}^{world} .$$

The device may encode the local transform matrix to represent the joint position.

Additionally or alternatively, encoding the joint position information may include performing temporal encoding. The device may calculate difference data between a current time and a previous time. For example, the device may calculate translation difference data (t_{delta}), rotation difference data (g_{delta}), and scale difference data (s_{delta}). As described above with respect to temporal encoding unit 406, translation difference may be calculated as

$${t}_{delta} = {R}_{prev}^{T} \times ( {t}_{curr} - {t}_{prev} ) .$$

Rotation difference may be calculated as

$${q}_{delta} = {q}_{prev}^{- 1} \times {q}_{curr} .$$

Scale difference may be calculated as s_{delta}=s_{curr}/sₚᵣₑᵥ.

Additionally or alternatively, encoding the joint position information may include quantizing components of the joint position data. The device may determine a minimum value (vₘᵢₙ), a maximum value (vₘₐₓ), and a bitrate (b) for a component. The device may calculate a quantized value (i) for the component according to the formula:

$$i = ( \frac{v - {v}_{min}}{{v}_{max} - {v}_{min}} ) \times ( {2}^{b} - 1 ) .$$

The device may send the encoded joint position information to another device participating in the AR communication session (474). For example, the device may packetize the encoded quaternion components, local transform matrices, difference data, and/or quantized values into a bitstream and transmit the bitstream via a network to a receiving device (e.g., UE 14 of FIG. 1).

In this manner, the method of FIG. 14 represents an example of a method of encoding animation data for augmented reality (AR) media data, including: receiving joint position information for a pre-defined skeleton for an avatar to be presented during an AR communication session; encoding the joint position information to form encoded joint position information; and sending the encoded joint position information to another device participating in the AR communication session.

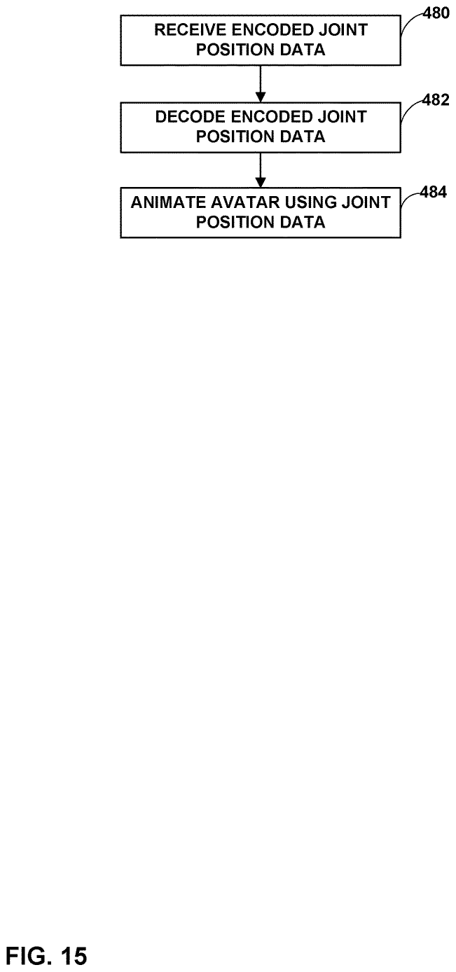

FIG. 15 is a flowchart illustrating an example method of decoding joint position data for a skeleton of an avatar per techniques of this disclosure. One or more processors implemented in circuitry of a device, such as media decoders 208 of UE 200 of FIG. 5, animation decompression unit 450 of FIG. 13, UE 14 of FIG. 1, or receiving device 240 of FIG. 6, may perform the method of FIG. 15.

The device may receive encoded joint position data for a pre-defined skeleton for an avatar to be presented during an AR communication session (480). The encoded joint position data may comport with the animation stream described with respect to, e.g., FIG. 12 and FIG. 14.

The device may decode the encoded joint position data (482). In some examples, the encoded joint position data includes a first quaternion component q1, a second quaternion component q2, and a third quaternion component q3 for a quaternion used to represent rotation of a joint of the pre-defined skeleton. To decode the encoded joint position data, the device may calculate a value for a fourth quaternion component q4 for the quaternion from q1, q2, and q3. For example, the device may calculate the value for the fourth quaternion component q4 according to the formula:

$${q}_{4} = \sqrt{1 - {q}_{1}^{2} - {q}_{2}^{2} - {q}_{3}^{2}} .$$

In some examples, q4 is larger than each of q1, q2, and q3, as the encoder may select the largest component to omit from the bitstream.

Additionally or alternatively, to decode the encoded joint position data, the device may perform inverse quantization. The encoded joint position data may include a quantized value i for a component of the joint position data. The device may determine a minimum value (vₘᵢₙ) for the component, a maximum value (vₘₐₓ) for the component, and a bitrate (b) for values of the component. The device may calculate an inverse quantized value for the component (v′) according to the formula:

$${v}^{′} = \frac{i}{{2}^{b} - 1} \times ( {v}_{max} - {v}_{min} ) + {v}_{min} .$$

Additionally or alternatively, the encoded joint position data may include difference data, such as a quaternion difference value, a translation difference value, and/or a scale difference value. To decode the encoded joint position data, the device may perform temporal decoding. The device may determine a quaternion transform matrix for a previous time (qₚᵣₑᵥ), decode a quaternion difference value (q_{deta}), and calculate a current quaternion transform matrix for a current time (q_{curr}) according to q_{curr}=qₚᵣₑᵥ× q_{delta}. The device may determine a translation transform matrix for the previous time (tₚᵣₑᵥ), determine a rotated translation matrix for the previous time (Rₚᵣₑᵥ), decode a translation difference value (t_{deta}), and calculate a current transform matrix for the current time (t_{curr}) according to t_{curr}=tₚᵣₑᵥ+Rₚᵣₑᵥ×t_{delta}. The device may determine a scale transform matrix for the previous time (sₚᵣₑᵥ), decode a scale difference value (s_{delta}), and calculate a current scale transform matrix for the current time (s_{curr}) according to s_{curr}=sₚᵣₑᵥ×s_{delta}.

Additionally or alternatively, the encoded joint position data may include a local transform matrix for a child joint j to a parent joint p of the skeleton. To decode the encoded joint position data, the device may calculate a global transform matrix for the child joint j using the local transform matrix for the child joint j and a global transform matrix for the parent joint p. For example, where the global transform matrix for the parent joint p comprises

$$( {T}_{p}^{world} )$$

and the local transform matrix comprises

$$( {T}_{j}^{local} ) ,$$

the device may calculate the global transform matrix for the child joint (Tⱼ^{world) according to}

$${T}_{j}^{world} = {T}_{p}^{world} \times {T}_{j}^{local} .$$

The device may animate the avatar according to the joint position data (484). For example, the device may animate the avatar according to the global transform matrix for the child joint j. In examples where temporal decoding is performed, the device may animate the base avatar according to the current quaternion transform matrix, the current transform matrix, and the current scale transform matrix.

In this manner, the method of FIG. 15 represents an example of a method of decoding animation data for augmented reality (AR) media data, including: receiving encoded joint position data for a pre-defined skeleton for an avatar to be presented during an AR communication session; decoding the encoded joint position data; and animating the avatar according to the joint position data.

Various examples of the techniques of this disclosure are summarized in the following clauses:
Clause 1: A method of decoding animation data for augmented reality (AR) media data, the method comprising: receiving encoded joint position data for a pre-defined skeleton for an avatar to be presented during an AR communication session; decoding the encoded joint position data; and animating the avatar according to the joint position data.
Clause 2: The method of clause 1, wherein the encoded joint position data comprises a first quaternion component q₁, a second quaternion component q₂, and a third quaternion component q₃ for a quaternion used to represent rotation of a joint of the pre-defined skeleton, and wherein decoding the encoded joint position data comprises calculating a value for a fourth quaternion component q₄ for the quaternion from q₁, q₂, and q₃.
Clause 3: The method of any of clauses 1 and 2, wherein the encoded joint position data comprises a local transform matrix for a child joint j to a parent joint p of the skeleton, and wherein decoding the encoded joint position data comprises calculating a global transform matrix for the child joint j using the local transform matrix for the child joint j and a global transform matrix for the parent joint p.
Clause 4: The method of any of clauses 1-3, wherein the encoded joint position data comprises a quaternion difference value, a translation difference value, and a scale difference value.
Clause 5: The method of any of clauses 1-4, wherein the encoded joint position data comprises a quantized value i for a component of the joint position data, and wherein decoding the encoded joint position data comprises inverse quantizing the quantized value i.
Clause 6: A method of encoding animation data for augmented reality (AR) media data, the method comprising: receiving joint position information for a pre-defined skeleton for an avatar to be presented during an AR communication session; encoding the joint position information to form encoded joint position information; and sending the encoded joint position information to another device participating in the AR communication session.
Clause 7: The method of clause 6, wherein the encoded joint position data comprises a first quaternion component q₁, a second quaternion component q₂, and a third quaternion component q₃ for a quaternion used to represent rotation of a joint of the pre-defined skeleton.
Clause 8: The method of any of clauses 6 and 7, wherein the encoded joint position data comprises a local transform matrix for a child joint j to a parent joint p of the skeleton.
Clause 9: The method of any of clauses 6-8, wherein the encoded joint position data comprises a quaternion difference value, a translation difference value, and a scale difference value.
Clause 10: The method of any of clauses 6-9, wherein the encoded joint position data comprises a quantized value i for a component of the joint position data.
Clause 11: A method of decoding animation data for augmented reality (AR) media data, the method comprising: decoding a first quaternion component q₁, a second quaternion component q₂, and a third quaternion component q₃ for a quaternion used to represent rotation of a joint of a skeleton; calculating a value for a fourth quaternion component q₄ for the quaternion from q₁, q₂, and q₃; and animating a base avatar according to the quaternion during an AR communication session.
Clause 12: The method of clause 11, wherein calculating the value for the fourth quaternion component q₄ from q₁, q₂, and q₃ comprises calculating the value for the fourth quaternion component q₄ according to:

$${q}_{4} = \sqrt{1 - {q}_{1}^{2} - {q}_{2}^{2} - {q}_{3}^{2}} .$$

Clause 13: The method of any of clauses 11 and 12, wherein q₄ is larger than each of q₁, q₂, and q₃.
Clause 14: A method of decoding animation data for augmented reality (AR) media data, the method comprising: determining a global transform matrix for a parent joint p of a skeleton

$$( {T}_{p}^{world} ) ;$$

determining a local transform matrix for a child joint j to the parent joint p of the skeleton

$$( {T}_{j}^{local} ) ;$$

calculating a global transform matrix for the child joint

$$j ( {T}_{j}^{world} )$$

according to:

$${T}_{j}^{world} = {T}_{p}^{world} \times {T}_{j}^{local} ;$$

and animating a base avatar according to the global transform matrix for the child joint j.
Clause 15: A method comprising a combination of the method of any of clauses 1 and 13 and the method of clause 14.
Clause 16: A method of decoding animation data for augmented reality (AR) media data, the method comprising: determining a quaternion transform matrix for a previous time (qₚᵣₑᵥ); decoding a quaternion difference value (q_{delta}); calculating a current quaternion transform matrix for a current time (q_{curr}) according to: q_{curr}=qₚᵣₑᵥ× q_{delta}; determining a translation transform matrix for the previous time (tₚᵣₑᵥ); determining a rotated translation matrix for the previous time (Rₚᵣₑᵥ); decoding a translation difference value (t_{delta}); calculating a current transform matrix for the current time (t_{curr}) according to: t_{curr}=tₚᵣₑᵥ+Rₚᵣₑᵥ×t_{delta}; determining a scale transform matrix for the previous time (sₚᵣₑᵥ); decoding a scale difference value (s_{delta}); and calculating a current scale transform matrix for the current time (s_{curr}) according to: s_{curr}=sₚᵣₑᵥ×s_{delta}.
Clause 17: A method comprising a combination of the method of any of clauses 1-15 and the method of clause 16.
Clause 18: The method of any of clauses 16 and 17, further comprising animating a base avatar according to the current quaternion transform matrix, the current transform matrix, and the current scale transform matrix.
Clause 19: A method of decoding animation data for augmented reality (AR) media data, the method comprising: determining a minimum value for a component (vₘᵢₙ) representing animation data for an AR communication session; determining a maximum value for the component (vₘₐₓ); determining a bitrate for values of the component (b); obtaining a quantized value i for the component; and calculating an inverse quantized value for the component (v′) according to

$${v}^{′} = \frac{i}{{2}^{b} - 1} \times ( {v}_{max} - {v}_{min} ) + {v}_{min} .$$

Clause 20: A method comprising a combination of the method of any of clauses 1-18 and the method of clause 19.
Clause 21: A method of encoding animation data for augmented reality (AR) media data, the method comprising: determining quaternion component values w, x, y, and z for a quaternion representing rotation of a joint of a skeleton to be used to animate a base avatar for an AR communication session; determining a largest quaternion component (qₘₐₓ) of the quaternion component values w, x, y, and z; and encoding quaternion component values, other than the qₘₐₓ.
Clause 22: The method of clause 21, further comprising: extracting rotation and scale components from a matrix M for the joint according to:

$${s}_{x} = \sqrt{{M}_{11}^{2} + {M}_{21}^{2} + {M}_{31}^{2}} ; = \sqrt{{M}_{12}^{2} + {M}_{22}^{2} + {M}_{32}^{2}} ; \\ and {s}_{z} = \sqrt{{M}_{13}^{2} + {M}_{23}^{2} + {M}_{33}^{2}} ;$$

extracting a notation value Rᵢⱼ according to

$${R}_{ij} = \frac{{M}_{ij}}{{s}_{j}} ;$$

and converting the rotation value Rᵢⱼ to the quaternion component values w, x, y, and z according to: trace=R₁₁+R₂₂+R₃₃; s=0.5/\sqrt{trace+1.0}; w=0.25/s; x=(R₃₂− R₂₃)×s; y=(R₁₃− R₃₁)×s; and z=(R₂₁− R₁₂)×s.
Clause 23: A method of encoding animation data for augmented reality (AR) media data, the method comprising: determining an inverse world transform matrix for a parent node p to a current joint node j

$${( {T}_{p}^{world} )}^{- 1} ,$$

wherein the parent node p and the current node j are included in a skeleton for animating a base model during an AR communication session; determining a world transform matrix for the current joint node

$$j ( {T}_{j}^{world} ) ;$$

calculating a local transform matrix for the current joint node j according to

$${T}_{j}^{local} = {( {T}_{p}^{world} )}^{- 1} \times {T}_{j}^{world} ;$$

and encoding the local transform matrix to encode animation data for the AR communication session.
Clause 24: A method comprising a combination of the method of any of clauses 21 and 22 and the method of clause 23.
Clause 25: The method of any of clauses 23 and 24, further comprising performing the method of clause 23 for each node of the skeleton in hierarchical order.
Clause 26: A method of encoding animation data for augmented reality (AR) media data, the method comprising: determining a rotated translation transform matrix for a previous time

$$( {R}_{prev}^{T} ) ;$$

determining a translation transform matrix for the previous time (tₚᵣₑᵥ); determining a current translation transform matrix for a current time (t_{curr}); calculating translation difference data according to

$${t}_{d e l t a} = {R}_{prev}^{T} \times ( {t}_{curr} - {t}_{p r e v} ) ;$$

determining an inverse rotation transform matrix for the previous time (qₚᵣₑᵥ⁻¹); determining a current rotation transform matrix for the current time (q_{curr}); calculating rotation difference data according to

$${q}_{delta} = {q}_{p r e v}^{- 1} \times {q}_{c u r r} ;$$

determining a scale transform matrix for the previous time (sₚᵣₑᵥ); determining a current scale transform matrix for the current time (s_{curr}); and calculating scale difference data according to

$${s}_{d e l t a} = \frac{{s}_{curr}}{{s}_{p r e v}} .$$

Clause 27: A method comprising a combination of the method of any of clauses 21-25 and the method of clause 26.
Clause 28: A method of encoding animation data for augmented reality (AR) media data, the method comprising: determining a minimum value for a component (vₘᵢₙ) representing animation data for an AR communication session; determining a maximum value for the component (vₘₐₓ); determining a bitrate for values of the component (b); and calculating a quantized value for the component (i) according to

$$i = ( \frac{v - {v}_{min}}{{v}_{max} - {v}_{min}} \times ( {2}^{b} - 1 ) ) .$$

Clause 29: A method comprising a combination of the method of any of clauses 21-27 and the method of clause 28.
Clause 30: A method of communicating augmented reality (AR) media data, the method comprising: obtaining a remote base avatar model of a remote user of a remote user equipment (UE) device; decoding remote animation data according to the method of any of clauses 1-20 to form decoded remote animation data; animating the remote base avatar model using the decoded remote animation data; generating local animation data representing movements of a local user; and encoding the local animation data according to the method of any of clauses 21-29.
Clause 31: A device for communicating augmented reality (AR) media data, the device comprising one or more means for performing the method of any of clauses 1-30.
Clause 32: The device of clause 31, wherein the one or more means comprise a memory configured to store AR media data and one or more processors implemented in circuitry.
Clause 33: A device for decoding augmented reality (AR) media data, the device comprising: means for receiving encoded joint position data for a pre-defined skeleton for an avatar to be presented during an AR communication session; means for decoding the encoded joint position data; and means for animating the avatar according to the joint position data.
Clause 34: A device for decoding augmented reality (AR) media data, the device comprising: means for decoding a first quaternion component q₁, a second quaternion component q₂, and a third quaternion component q₃ for a quaternion used to represent rotation of a joint of a skeleton; means for calculating a value for a fourth quaternion component q₄ for the quaternion from q₁, q₂, and q₃; and means for animating a base avatar according to the quaternion during an AR communication session.
Clause 35: A device for decoding augmented reality (AR) media data, the device comprising: means for determining a global transform matrix for a parent joint p of a skeleton

$$( {T}_{p}^{world} ) ;$$

means for determining a local transform matrix for a child joint j to the parent joint p of the skeleton

$$( {T}_{j}^{local} ) ;$$

means for calculating a global transform matrix for the child joint

$$j ( {T}_{j}^{world} )$$

according to:

$${T}_{j}^{world} = {T}_{p}^{world} \times {T}_{j}^{local} ;$$

and means for animating a base avatar according to the global transform matrix for the child joint j.
Clause 36: A device for decoding augmented reality (AR) media data, the device comprising: means for determining a quaternion transform matrix for a previous time (qₚᵣₑᵥ); means for decoding a quaternion difference value (q_{delta}); means for calculating a current quaternion transform matrix for a current time (q_{curr}) according to: q_{curr}=qₚᵣₑᵥ× q_{delta}; means for determining a translation transform matrix for the previous time (tₚᵣₑᵥ); means for determining a rotated translation matrix for the previous time (Rₚᵣₑᵥ); means for decoding a translation difference value (t_{delta}); means for calculating a current transform matrix for the current time (t_{curr}) according to: t_{curr}=tₚᵣₑᵥ+Rₚᵣₑᵥ×t_{delta}; means for determining a scale transform matrix for the previous time (sₚᵣₑᵥ); means for decoding a scale difference value (s_{delta}); and means for calculating a current scale transform matrix for the current time (s_{curr}) according to:

$${s}_{curr} = {s}_{prev} \times {s}_{delta} .$$

Clause 37: A device for decoding augmented reality (AR) media data, the device comprising: means for determining a minimum value for a component (vₘᵢₙ) representing animation data for an AR communication session; means for determining a maximum value for the component (vₘₐₓ); means for determining a bitrate for values of the component (b); and means for calculating an inverse quantized value for the component (v′) according to

$${v}^{′} = \frac{i}{{2}^{b} - 1} \times ( {v}_{max} - {v}_{min} ) + {v}_{min} .$$

Clause 38: A device for encoding augmented reality (AR) media data, the device comprising: means for receiving joint position information for a pre-defined skeleton for an avatar to be presented during an AR communication session; means for encoding the joint position information to form encoded joint position information; and means for sending the encoded joint position information to another device participating in the AR communication session.
Clause 39: A device for encoding augmented reality (AR) media data, the device comprising: means for determining quaternion component values w, x, y, and z for a quaternion representing rotation of a joint of a skeleton to be used to animate a base avatar for an AR communication session; means for determining a largest quaternion component (qₘₐₓ) of the quaternion component values w, x, y, and z; and means for encoding q1, q2, and q3 as quaternion component values other than the qₘₐₓ of the quaternion component values.
Clause 40: A device for encoding augmented reality (AR) media data, the device comprising: means for determining an inverse world transform matrix for a parent node p to a current joint node

$${j ( {T}_{p}^{world} )}^{- 1} ,$$

wherein the parent node p and the current node j are included in a skeleton for animating a base model during an AR communication session; means for determining a world transform matrix for the current joint node

$$j ( {T}_{j}^{world} ) ;$$

means for calculating a local transform matrix for the current joint node j according to

$${T}_{j}^{local} = {( {T}_{p}^{world} )}^{- 1} \times {T}_{j}^{world} ;$$

and means for encoding the local transform matrix to encode animation data for the AR communication session.
Clause 41: A device for encoding augmented reality (AR) media data, the device comprising: means for determining a rotated translation transform matrix for a previous time

$$( {R}_{prev}^{T} ) ;$$

means for determining a translation transform matrix for the previous time (tₚᵣₑᵥ); means for determining a current translation transform matrix for a current time (t_{curr}); means for calculating translation difference data according to

$${t}_{delta} = {R}_{prev}^{T} \times ( {t}_{curr} - {t}_{prev} ) ;$$

means for determining an inverse rotation transform matrix for the previous time

$$( {q}_{prev}^{- 1} ) ;$$

means for determining a current rotation transform matrix for the current time (q_{curr}); means for calculating rotation difference data according to

$${q}_{delta} = {q}_{prev}^{- 1} \times {q}_{curr} ;$$

means for determining a scale transform matrix for the previous time (sₚᵣₑᵥ); means for determining a current scale transform matrix for the current time (s_{curr}); and means for calculating scale difference data according to

$${s}_{delta} = \frac{{s}_{curr}}{{s}_{prev}} .$$

Clause 42: A device for encoding augmented reality (AR) media data, the device comprising: means for determining a minimum value for a component (vₘᵢₙ) representing animation data for an AR communication session; means for determining a maximum value for the component (vₘₐₓ); means for determining a bitrate for values of the component (b); and means for calculating a quantized value for the component (i) according to

$$i = ( \frac{v - {v}_{min}}{{v}_{max} - {v}_{min}} \times ( {2}^{b} - 1 ) ) .$$

Clause 43: A method of decoding animation data for augmented reality (AR) media data, the method comprising: receiving encoded joint position data for a pre-defined skeleton for an avatar to be presented during an AR communication session; decoding the encoded joint position data; and animating the avatar according to the joint position data.
Clause 44: The method of clause 43, wherein the encoded joint position data comprises a first quaternion component q₁, a second quaternion component q₂, and a third quaternion component q₃ for a quaternion used to represent rotation of a joint of the pre-defined skeleton, and wherein decoding the encoded joint position data comprises calculating a value for a fourth quaternion component q₄ for the quaternion from q₁, q₂, and q₃.
Clause 45: The method of clause 44, wherein calculating the value for the fourth quaternion component q₄ comprises calculating the value for the fourth quaternion component according to:

$${q}_{4} = \sqrt{1 - {q}_{1}^{2} - {q}_{2}^{2} - {q}_{3}^{2}} .$$

Clause 46: The method of clause 44, wherein q₄ is larger than each of q₁, q₂, and q₃.
Clause 47: The method of any of clauses 43-46, wherein the encoded joint position data comprises a local transform matrix for a child joint j to a parent joint p of the skeleton, and wherein decoding the encoded joint position data comprises calculating a global transform matrix for the child joint j using the local transform matrix for the child joint j and a global transform matrix for the parent joint p.
Clause 48: The method of clause 47, wherein the global transform matrix for the parent joint p comprises

$$( {T}_{p}^{world} ) ,$$

wherein the local transform matrix comprises

$$( {T}_{j}^{local} ) ,$$

and wherein calculating the global transform matrix for the child joint comprises calculating the global transform matrix for the child joint

$$( {T}_{j}^{world} )$$

according to:

$${T}_{j}^{world} = {T}_{p}^{world} \times {T}_{j}^{local} .$$

Clause 49: The method of clause 47, wherein animating the avatar comprises animating the avatar according to the global transform matrix for the child joint j.
Clause 50: The method of any of clauses 43-49, wherein the encoded joint position data comprises a quaternion difference value, a translation difference value, and a scale difference value.
Clause 51: The method of any of clauses 43-50, wherein the encoded joint position data comprises a quantized value i for a component of the joint position data, and wherein decoding the encoded joint position data comprises inverse quantizing the quantized value i.
Clause 52: The method of any of clauses 43-51, further comprising: determining a quaternion transform matrix for a previous time (qₚᵣₑᵥ); decoding a quaternion difference value (q_{delta}); calculating a current quaternion transform matrix for a current time (q_{curr}) according to:
   q_{curr}=qₚᵣₑᵥ× q_{delta}; determining a translation transform matrix for the previous time (tₚᵣₑᵥ); determining a rotated translation matrix for the previous time (Rₚᵣₑᵥ); decoding a translation difference value (t_{deta}); calculating a current transform matrix for the current time (t_{curr}) according to: t_{curr}=tₚᵣₑᵥ+Rₚᵣₑᵥ×t_{delta}; determining a scale transform matrix for the previous time (sₚᵣₑᵥ); decoding a scale difference value (s_{deta}); and calculating a current scale transform matrix for the current time (s_{curr}) according to:

$${s}_{curr} = {s}_{prev} \times {s}_{delta} .$$

Clause 53: The method of clause 52, wherein animating the base avatar comprises animating the base avatar according to the current quaternion transform matrix, the current transform matrix, and the current scale transform matrix.
Clause 54: The method of any of clauses 43-53, further comprising: determining a minimum value for a component (vₘᵢₙ) representing the animation data for the AR communication session; determining a maximum value for the component (vₘₐₓ); determining a bitrate for values of the component (b); obtaining a quantized value i for the component; and calculating an inverse quantized value for the component (v′) according to

$${v}^{′} = \frac{i}{{2}^{b} - 1} \times ( {v}_{max} - {v}_{min} ) + {v}_{min} .$$

Clause 55: A device for decoding animation data for augmented reality (AR) media data, the device comprising: a memory configured to store an avatar to be presented during an AR communication session; and a processing system implemented in circuitry and configured to: receive encoded joint position data for a pre-defined skeleton for an avatar to be presented during an AR communication session; decode the encoded joint position data; and animate the avatar according to the joint position data.
Clause 56: The device of clause 55, wherein the encoded joint position data comprises a first quaternion component q₁, a second quaternion component q₂, and a third quaternion component q₃ for a quaternion used to represent rotation of a joint of the pre-defined skeleton, and wherein to decode the encoded joint position data, the processing system is configured to calculate a value for a fourth quaternion component q₄ for the quaternion from q₁, q₂, and q₃.
Clause 57: The device of clause 55, wherein the encoded joint position data comprises a local transform matrix for a child joint j to a parent joint p of the skeleton, and wherein decoding the encoded joint position data comprises calculating a global transform matrix for the child joint j using the local transform matrix for the child joint j and a global transform matrix for the parent joint p.
Clause 58: A method of encoding animation data for augmented reality (AR) media data, the method comprising: receiving joint position information for a pre-defined skeleton for an avatar to be presented during an AR communication session; encoding the joint position information to form encoded joint position information; and sending the encoded joint position information to another device participating in the AR communication session.
Clause 59: The method of clause 58, wherein the encoded joint position data comprises a first quaternion component q₁, a second quaternion component q₂, and a third quaternion component q₃ for a quaternion used to represent rotation of a joint of the pre-defined skeleton.
Clause 60: The method of clause 59, further comprising: determining that a fourth quaternion component q₄ is a largest quaternion component (qₘₐₓ) of the joint position data; and omitting encoding of the fourth quaternion component q₄.
Clause 61: The method of any of clauses 58-60, wherein the encoded joint position data comprises a local transform matrix for a child joint j to a parent joint p of the skeleton.
Clause 62: The method of any of clauses 58-61, wherein the encoded joint position data comprises a quaternion difference value, a translation difference value, and a scale difference value.
Clause 63: The method of any of clauses 58-62, wherein the encoded joint position data comprises a quantized value i for a component of the joint position data.
Clause 64: The method of any of clauses 58-63, further comprising: determining an inverse world transform matrix for a parent node p to a current joint node j

$${( {T}_{p}^{world} )}^{- 1} ,$$

wherein the parent node p and the current node j are included in the pre-defined skeleton; determining a world transform matrix for the current joint node

$$j ( {T}_{j}^{world} ) ;$$

calculating a local transform matrix for the current joint node j according to

$${T}_{j}^{local} = {( {T}_{p}^{world} )}^{- 1} \times {T}_{j}^{world} ;$$

and encoding the local transform matrix to encode animation data for the AR communication session.
Clause 65: The method of any of clauses 58-64, further comprising: determining a rotated translation transform matrix for a previous time

$$( {R}_{prev}^{T} ) ;$$

determining a translation transform matrix for the previous time (tₚᵣₑᵥ); determining a current translation transform matrix for a current time (t_{curr}); calculating translation difference data according to

$${t}_{delta} = {R}_{prev}^{T} \times ( {t}_{curr} - {t}_{prev} ) ;$$

determining an inverse rotation transform matrix for the previous time

$$( {q}_{prev}^{- 1} ) ;$$

determining a current rotation transform matrix for the current time (q_{curr}); calculating rotation difference data according to

$${q}_{delta} = {q}_{prev}^{- 1} \times {q}_{curr} ;$$

determining a scale transform matrix for the previous time (sₚᵣₑᵥ); determining a current scale transform matrix for the current time (s_{curr}); and calculating scale difference data according to

$${s}_{delta} = \frac{{s}_{curr}}{{s}_{prev}} .$$

Clause 66: The method of any of clauses 58-65, further comprising: determining a minimum value for a component (vₘᵢₙ) representing animation data for an AR communication session; determining a maximum value for the component (vₘₐₓ); determining a bitrate for values of the component (b); and calculating a quantized value for the component (i) according to

$$i = ( \frac{v - {v}_{min}}{{v}_{max} - {v}_{min}} \times ( {2}^{b} - 1 ) ) .$$

Clause 67: A device for encoding animation data for augmented reality (AR) media data, the device comprising: a memory configured to store an avatar to be presented during an AR communication session; and a processing system implemented in circuitry and configured to: receive joint position information for a pre-defined skeleton of the avatar; encode the joint position information to form encoded joint position information; and send the encoded joint position information to another device participating in the AR communication session.
Clause 68: The device of clause 67, wherein the encoded joint position data comprises a first quaternion component q₁, a second quaternion component q₂, and a third quaternion component q₃ for a quaternion used to represent rotation of a joint of the pre-defined skeleton.
Clause 69: The device of clause 67, wherein the encoded joint position data comprises a local transform matrix for a child joint j to a parent joint p of the skeleton.
Clause 70: The device of clause 67, wherein the processing system is further configured to: determine an inverse world transform matrix for a parent node p to a current joint node

$${j ( {T}_{p}^{world} )}^{- 1} ,$$

wherein the parent node p and the current node j are included in the pre-defined skeleton; determine a world transform matrix for the current joint node

$$j ( {T}_{j}^{world} ) ;$$

calculate a local transform matrix for the current joint node j according to

$${T}_{j}^{local} = {( {T}_{p}^{world} )}^{- 1} \times {T}_{j}^{world} ;$$

and encode the local transform matrix to encode animation data for the AR communication session.
Clause 71: The device of clause 67, wherein the processing system is further configured to: determine a rotated translation transform matrix for a previous time

$$( {R}_{prev}^{T} ) ;$$

determine a translation transform matrix for the previous time (tₚᵣₑᵥ); determine a current translation transform matrix for a current time (t_{curr}); calculate translation difference data according to

$${t}_{delta} = {R}_{prev}^{T} \times ( {t}_{curr} - {t}_{prev} ) ;$$

determine an inverse rotation transform matrix for the previous time

$$( {q}_{prev}^{- 1} ) ;$$

determine a current rotation transform matrix for the current time (q_{curr}); calculate rotation difference data according to

$${q}_{delta} = {q}_{prev}^{- 1} \times {q}_{curr} ;$$

determine a scale transform matrix for the previous time (sₚᵣₑᵥ); determine a current scale transform matrix for the current time (s_{curr}); and calculate scale difference data according to

$${s}_{delta} = \frac{{s}_{curr}}{{s}_{prev}} .$$

Clause 72: The device of clause 67, wherein the processing system is further configured to: determine a minimum value for a component (vₘᵢₙ) representing animation data for an AR communication session; determine a maximum value for the component (vₘₐₓ); determine a bitrate for values of the component (b); and calculate a quantized value for the component (i) according to

$$i = ( \frac{v - {v}_{min}}{{v}_{max} - {v}_{min}} \times ( {2}^{b} - 1 ) ) .$$

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding animation data for augmented reality (AR) media data, the method comprising:
receiving encoded joint position data for a pre-defined skeleton for an avatar to be presented during an AR communication session;
decoding the encoded joint position data to form joint position data; and
animating the avatar according to the joint position data.

2. The method of claim 1, wherein the encoded joint position data comprises a first quaternion component q₁, a second quaternion component q₂, and a third quaternion component q₃ for a quaternion used to represent rotation of a joint of the pre-defined skeleton, and wherein decoding the encoded joint position data comprises calculating a value for a fourth quaternion component q₄ for the quaternion from q₁, q₂, and q₃.

3. The method of claim 2, wherein calculating the value for the fourth quaternion component q₄ comprises calculating the value for the fourth quaternion component according to:
$${q}_{4} = \sqrt{1 - {q}_{1}^{2} - {q}_{2}^{2} - {q}_{3}^{2}} .$$

4. The method of claim 2, wherein q₄ is larger than each of q₁, q₂, and q₃.

5. The method of claim 1, wherein the encoded joint position data comprises a local transform matrix for a child joint j to a parent joint p of the pre-defined skeleton, and wherein decoding the encoded joint position data comprises calculating a global transform matrix for the child joint j using the local transform matrix for the child joint j and a global transform matrix for the parent joint p.

6. The method of claim 5, wherein the global transform matrix for the parent joint p comprises
$$( {T}_{p}^{world} ) ,$$
wherein the local transform matrix comprises
$$( {T}_{j}^{local} ) ,$$
and wherein calculating the global transform matrix for the child joint comprises calculating the global transform matrix for the child joint
$$( {T}_{j}^{world} )$$
according to:
$${T}_{j}^{world} = {T}_{p}^{world} \times {T}_{j}^{local} .$$

7. The method of claim 5, wherein animating the avatar comprises animating the avatar according to the global transform matrix for the child joint j.

8. The method of claim 1, wherein the encoded joint position data comprises a quaternion difference value, a translation difference value, and a scale difference value.

9. The method of claim 1, wherein the encoded joint position data comprises a quantized value i for a component of the joint position data, and wherein decoding the encoded joint position data comprises inverse quantizing the quantized value i.

10. The method of claim 1, further comprising:
determining a quaternion transform matrix for a previous time (qₚᵣₑᵥ) for the avatar;
decoding a quaternion difference value (q_{delta});
calculating a current quaternion transform matrix for a current time (q_{curr}) according to:
$${q}_{curr} = {q}_{prev} \times {q}_{delta} ;$$
determining a translation transform matrix for the previous time (tₚᵣₑᵥ);
determining a rotated translation matrix for the previous time (Rₚᵣₑᵥ);
decoding a translation difference value (t_{delta});
calculating a current transform matrix for the current time (t_{curr}) according to:
$${t}_{curr} = {t}_{prev} + {R}_{prev} \times {t}_{delta} ;$$
determining a scale transform matrix for the previous time (sₚᵣₑᵥ);
decoding a scale difference value (s_{delta}); and
calculating a current scale transform matrix for the current time (s_{curr}) according to:
$${s}_{curr} = {s}_{prev} \times {s}_{delta} .$$

11. The method of claim 10, wherein animating the avatar comprises animating the avatar according to the current quaternion transform matrix, the current transform matrix, and the current scale transform matrix.

12. The method of claim 1, further comprising:
determining a minimum value for a component (vₘᵢₙ) representing animation data to be used to animate the avatar;
determining a maximum value for the component (vₘₐₓ);
determining a bitrate for values of the component (b);
obtaining a quantized value i for the component; and
calculating an inverse quantized value for the component (v′) according to
$${v}^{′} = \frac{i}{{2}^{b} - 1} \times ( {v}_{max} - {v}_{min} ) + {v}_{min} .$$

13. A device for decoding animation data for augmented reality (AR) media data, the device comprising:
a memory configured to store an avatar to be presented during an AR communication session; and
a processing system implemented in circuitry and configured to:
receive encoded joint position data for a pre-defined skeleton for the avatar to be presented during the AR communication session;
decode the encoded joint position data to form joint position data; and
animate the avatar according to the joint position data.

14. The device of claim 13, wherein the encoded joint position data comprises a first quaternion component q₁, a second quaternion component q₂, and a third quaternion component q₃ for a quaternion used to represent rotation of a joint of the pre-defined skeleton, and wherein to decode the encoded joint position data, the processing system is configured to calculate a value for a fourth quaternion component q₄ for the quaternion from q₁, q₂, and q₃.

15. The device of claim 13, wherein the encoded joint position data comprises a local transform matrix for a child joint j to a parent joint p of the pre-defined skeleton, and wherein decoding the encoded joint position data comprises calculating a global transform matrix for the child joint j using the local transform matrix for the child joint j and a global transform matrix for the parent joint p.

16. A method of encoding animation data for augmented reality (AR) media data, the method comprising:
receiving joint position data for a pre-defined skeleton for an avatar to be presented during an AR communication session;
encoding the joint position data to form encoded joint position data; and
sending the encoded joint position data to another device participating in the AR communication session.

17. The method of claim 16, wherein the encoded joint position data comprises a first quaternion component q₁, a second quaternion component q₂, and a third quaternion component q₃ for a quaternion used to represent rotation of a joint of the pre-defined skeleton.

18. The method of claim 17, further comprising:
determining that a fourth quaternion component q₄ is a largest quaternion component (qₘₐₓ) of the joint position data; and
omitting encoding of the fourth quaternion component q₄.

19. The method of claim 16, wherein the encoded joint position data comprises a local transform matrix for a child joint j to a parent joint p of the pre-defined skeleton.

20. The method of claim 16, wherein the encoded joint position data comprises a quaternion difference value, a translation difference value, and a scale difference value.

21. The method of claim 16, wherein the encoded joint position data comprises a quantized value i for a component of the joint position data.

22. The method of claim 16, further comprising:
determining an inverse world transform matrix for a parent node p to a current joint node
$${j ( {T}_{p}^{world} )}^{- 1} ,$$
wherein the parent node p and the current joint node j are included in the pre-defined skeleton;
determining a world transform matrix for the current joint node
$$j ( {T}_{j}^{world} ) ;$$
calculating a local transform matrix for the current joint node j according to
$${T}_{j}^{local} = {( {T}_{p}^{world} )}^{- 1} \times {T}_{j}^{world} ;$$
and
encoding the local transform matrix to encode animation data for the AR communication session.

23. The method of claim 16, further comprising:
determining a rotated translation transform matrix for a previous time
$$( {R}_{prev}^{T} )$$
for the avatar;
determining a translation transform matrix for the previous time (tₚᵣₑᵥ);
determining a current translation transform matrix for a current time (t_{curr});
calculating translation difference data according to
$${t}_{delta} = {R}_{prev}^{T} \times ( {t}_{curr} - {t}_{prev} ) ;$$
determining an inverse rotation transform matrix for the previous time
$$( {q}_{prev}^{- 1} ) ;$$
determining a current rotation transform matrix for the current time (q_{curr});
calculating rotation difference data according to
$${q}_{delta} = {q}_{prev}^{- 1} \times {q}_{curr} ;$$
determining a scale transform matrix for the previous time (sₚᵣₑᵥ);
determining a current scale transform matrix for the current time (s_{curr}); and
calculating scale difference data according to
$${s}_{delta} = \frac{{s}_{curr}}{{s}_{prev}} .$$

24. The method of claim 16, further comprising:
determining a minimum value for a component (vₘᵢₙ) representing animation data to be used to animate the avatar;
determining a maximum value for the component (vₘₐₓ);
determining a bitrate for values of the component (b); and
calculating a quantized value for the component (i) according to
$$i = ( \frac{v - {v}_{min}}{{v}_{max} - {v}_{min}} \times ( {2}^{b} - 1 ) ) .$$

25. A device for encoding animation data for augmented reality (AR) media data, the device comprising:
a memory configured to store an avatar to be presented during an AR communication session; and
a processing system implemented in circuitry and configured to:
receive joint position data for a pre-defined skeleton of the avatar;
encode the joint position data to form encoded joint position data; and
send the encoded joint position data to another device participating in the AR communication session.

26. The device of claim 25, wherein the encoded joint position data comprises a first quaternion component q₁, a second quaternion component q₂, and a third quaternion component q₃ for a quaternion used to represent rotation of a joint of the pre-defined skeleton.

27. The device of claim 25, wherein the encoded joint position data comprises a local transform matrix for a child joint j to a parent joint p of the pre-defined skeleton.

28. The device of claim 25, wherein the processing system is further configured to:
determine an inverse world transform matrix for a parent node p to a current joint node
$${j ( {T}_{p}^{world} )}^{- 1} ,$$
wherein the parent node p and the current joint node j are included in the pre-defined skeleton;
determine a world transform matrix for the current joint node
$$j ( {T}_{j}^{world} ) ;$$
calculate a local transform matrix for the current joint node j according to
$${T}_{j}^{local} = {( {T}_{p}^{world} )}^{- 1} \times {T}_{j}^{world} ;$$
and
encode the local transform matrix to encode animation data for the AR communication session.

29. The device of claim 25, wherein the processing system is further configured to:
determine a rotated translation transform matrix for a previous time
$$( {R}_{prev}^{T} )$$
for the avatar;
determine a translation transform matrix for the previous time (tₚᵣₑᵥ);
determine a current translation transform matrix for a current time (t_{curr});
calculate translation difference data according to
$${t}_{delta} = {R}_{prev}^{T} \times ( {t}_{curr} - {t}_{prev} ) ;$$
determine an inverse rotation transform matrix for the previous time (qₚᵣₑᵥ⁻¹);
determine a current rotation transform matrix for the current time (q_{curr});
calculate rotation difference data according to
$${q}_{delta} = {q}_{prev}^{- 1} \times {q}_{curr} ;$$
determine a scale transform matrix for the previous time (sₚᵣₑᵥ);
determine a current scale transform matrix for the current time (s_{curr}); and
calculate scale difference data according to
$${s}_{delta} = \frac{{s}_{curr}}{{s}_{prev}} .$$

30. The device of claim 25, wherein the processing system is further configured to:
determine a minimum value for a component (vₘᵢₙ) representing animation data to be used to animate the avatar;
determine a maximum value for the component (vₘₐₓ);
determine a bitrate for values of the component (b); and
calculate a quantized value for the component (i) according to
$$i = ( \frac{v - {v}_{min}}{{v}_{max} - {v}_{min}} \times ( {2}^{b} - 1 ) ) .$$
